(19) United States
(12) Patent Application Publication
(10) Pub. No.: US 2026/0371408 A1
(43) Pub. Date: Nov. 19, 2026

(54) NON-PRIMARY CHANNEL ACCESS (NPCA) OPERATION WITH TRIGGERED UPLINK TRANSMISSION

(71) Applicant: Ofinno, LLC, Reston, VA (US)

(72) Inventors: Serhat Erkucuk, Reston, VA (US); Leonardo Alisasis Lanante, Reston, VA (US); Esmael Hejazi Dinan, McLean, VA (US); Jeongki Kim, Fairfax, VA (US); Tuncer Baykas, Reston, VA (US); Jiayi Zhang, Rockville, MD (US); Javier Perez-Ramirez, Reston, VA (US)

(73) Assignee: Ofinno, LLC, Reston, VA (US)

(21) Appl. No.: 19/749,839

(22) Filed: Jul. 22, 2026

Related U.S. Application Data
(63) Continuation of application No. PCT/US2025/054075, filed on Nov. 5, 2025.
(60) Provisional application No. 63/717,935, filed on Nov. 8, 2024.

(51) Int. Cl. H04W 74/08; H04L 69/323

(52) U.S. Cl. CPC H04W 74/0866; H04L 69/323

(57) ABSTRACT

A station (STA) receives from an access point (AP) a beacon frame indicating a duration that indicates a time period during which the STA, while operating on a non-primary channel access (NPCA) primary channel (NPCA PCH), is not allowed to initiate a transmission opportunity (TXOP) on the NPCA PCH. The STA determines that a physical layer (PHY) protocol data unit (PPDU) being received via a primary channel (PCH) comprises an inter-basic service set (inter-BSS) PPDU, and switches from the PCH to the NPCA PCH based on determining that the PPDU being received via the PCH comprises an inter-BSS PPDU. The STA sets a timer based on the duration, and initiates a first TXOP on the NPCA PCH on condition that a value of the timer is zero.

### CROSS-REFERENCE TO RELATED APPLICATIONS

This application is a continuation of International Application No. PCT/US2025/054075, filed Nov. 5, 2025, which claims the benefit of U.S. Provisional Application No. 63/717,935, filed Nov. 8, 2024, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example trigger frame.

FIG. 5 illustrates an example multi-user request to send (MU-RTS) trigger frame.

FIG. 6 illustrates an example common info field.

FIG. 7 illustrates an example of a Request-to-Send (RTS)/Clear-to-Send (CTS) procedure.

FIG. 8 is an example that illustrates an MU-RTS/CTS procedure.

FIG. 9 is an example that illustrates non-primary channel access (NPCA) operation.

FIG. 10 illustrates virtual and physical carrier sense (CS) functions associated with primary and secondary channels for NPCA operation and non-NPCA operation.

FIG. 11 shows an example that illustrates NPCA operation.

FIG. 12 shows another example that illustrates NPCA operation.

FIG. 13 illustrates an example that highlights a problem that may arise in existing NPCA operation.

FIG. 14 shows an example that illustrates an example NPCA operation according to an embodiment.

FIG. 15 shows another example that illustrates another example NPCA operation according to an embodiment.

FIG. 16 shows another example that illustrates another example NPCA operation according to an embodiment.

FIG. 17 shows another example that illustrates another example NPCA operation according to an embodiment.

FIG. 18 shows another example that illustrates another example NPCA operation according to an embodiment.

FIG. 19 shows another example that illustrates another example NPCA operation according to an embodiment.

FIG. 20 illustrates an example process according to an embodiment.

FIG. 21 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++, or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

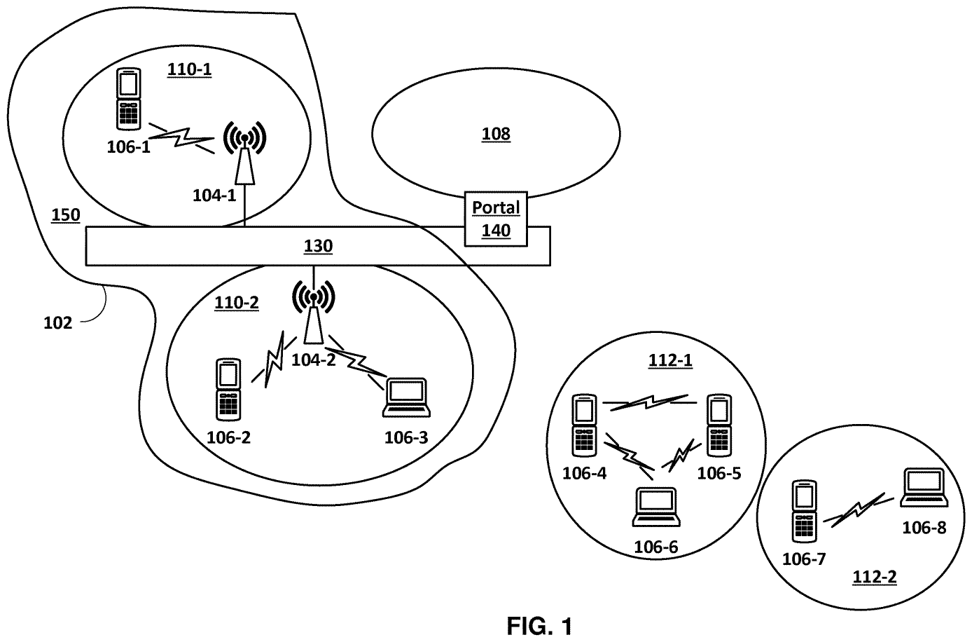

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be optionally formed through channel bonding of a primary 20 MHz channel and one or more 20 MHz secondary channels. For example, PPDUs may be transmitted over physical channels having bandwidths of 40 MHz, 80 MHz, 160 MHz, or 320 MHz by bonding together a primary 20 MHz channel and 1, 3, 7, or 15 secondary channel respectively. The primary channel is a common channel operation for all STAs where management frames are sent by the AP to ensure that all STAs (regardless of channel bonding support) can receive.

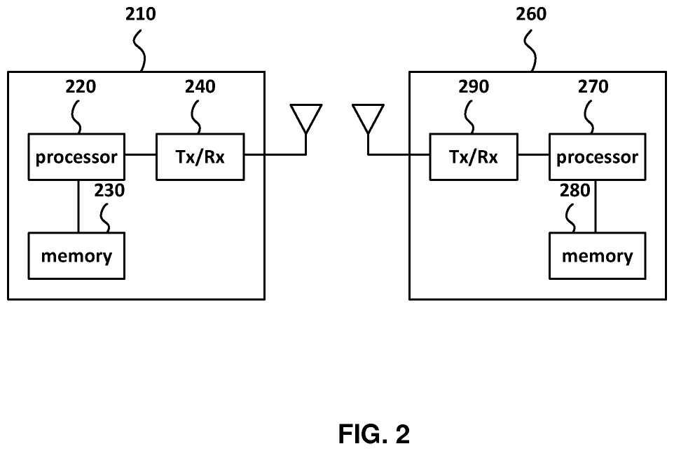

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

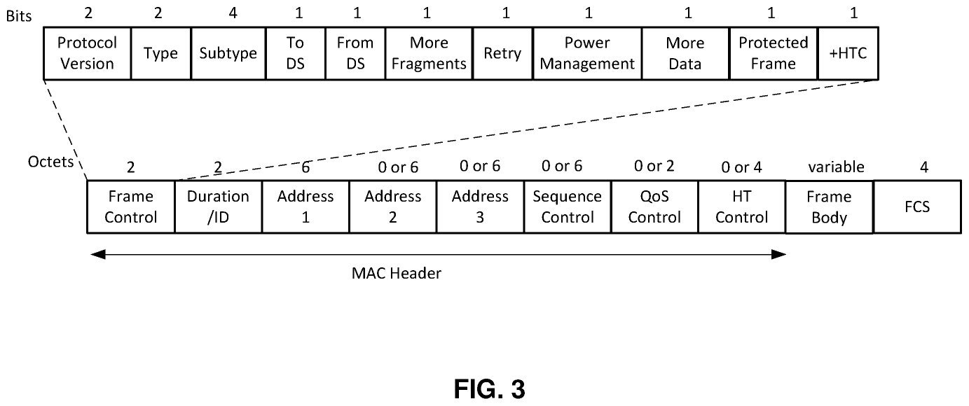

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS”, “From DS”, “More Fragments”, retry, power management, “More Data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

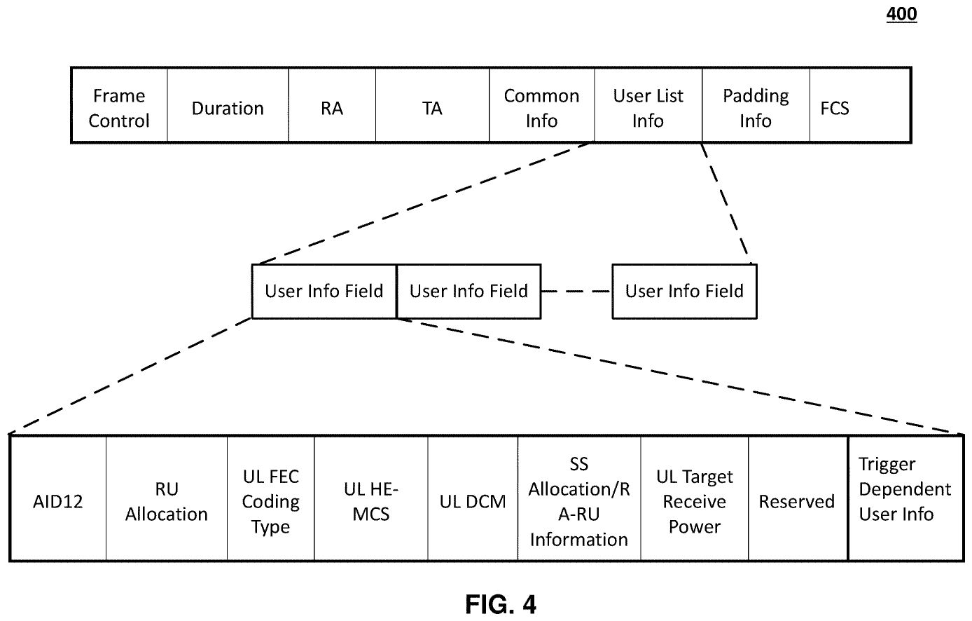

FIG. 4 illustrates an example trigger frame 400. Trigger frame 400 may correspond to a basic trigger frame as defined in the existing IEEE 802.11ax standard amendment. Trigger frame 400 may be used by an AP to allocate resources for and solicit one or more TB PPDU transmissions from one or more STAs. Trigger frame 400 may also carry other information required by a responding STA to transmit a TB PPDU to the AP.

As shown in FIG. 4, trigger frame 400 includes a Frame Control field, a Duration field, a receiver address (RA) field, a transmitter address (TA) field, a Common Info field, a User List Info field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 400 if trigger frame 400 is addressed to STAs that belong to a single BSS. The TA field is the transmitted BSSID if the trigger frame 400 is addressed to STAs from at least two different BSSs of the multiple BSSID set.

The common info field may have a format as illustrated by common info field 600 described further below. The common info field specifies a trigger frame type of trigger frame 400, a transmit power of trigger frame 400 in dBm, and several key parameters of a TB PPDU that is transmitted by a STA in response to trigger frame 400. The trigger frame type of a trigger frame used by an AP to receive QoS data using UL MU operation is referred to as a basic trigger frame.

The User List Info field contains a User Info field per STA addressed in trigger frame 400. The per STA User Info field includes, among others, an AID subfield, an RU Allocation subfield, a Spatial Stream (SS) Allocation subfield, an MCS subfield to be used by a STA in a TB PPDU transmitted in response to trigger frame 400, and a Trigger Dependent User Info subfield. The Trigger Dependent User Info subfield can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA.

The Padding field is optionally present in trigger frame 400 to extend the frame length to give recipient STAs enough time to prepare a response for transmission one SIFS (short interframe spacing) after the frame is received. The Padding field, if present, is at least two octets in length and is set to all 1 s.

The FCS field is used by a STA to validate a received frame and to interpret certain fields from the MAC headers of a frame.

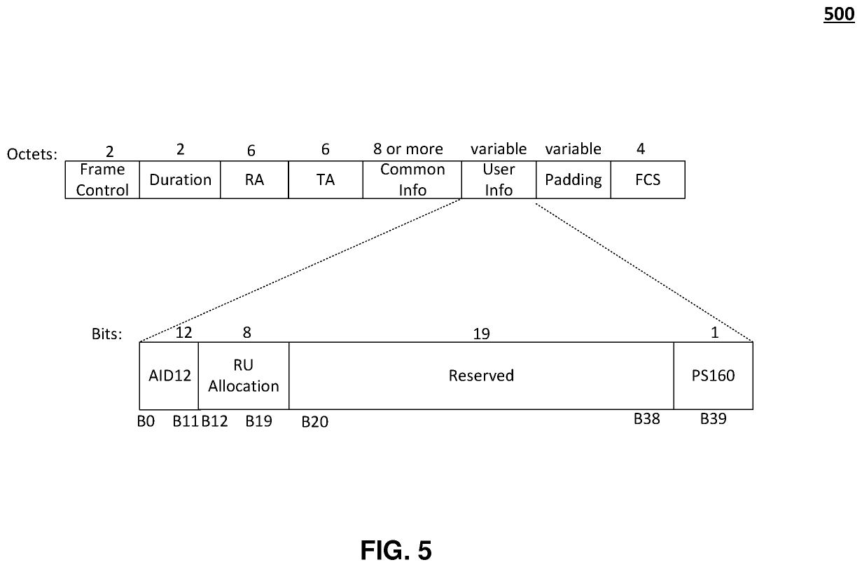

FIG. 5 illustrates an example multi-user request to send (MU-RTS) trigger frame 500. MU-RTS trigger frame 500 may be used by an AP to solicit simultaneous CTS frames from multiple STAs to transmit a downlink (DL) MU PPDU to the multiple STAs. As shown in FIG. 5, MU-RTS trigger frame 500 may comprise a frame control field, a duration field, an RA field, a TA field, a common info field, one or more user info fields, a padding field, and an FCS field. The frame control, TA, RA, padding, and FCS fields may be similar to the corresponding fields of trigger frame 400 described above. The common info field may have a format as illustrated by common info field 600 described further below. The duration field may be set to the time, in microseconds, required to transmit the DL MU PPDU, plus the time required to transmit one CTS frame, one ACK frame (if required), and three SIFS periods.

The one or more user info fields correspond respectively to the one or more STAs solicited by MU-RTS trigger frame 500. As shown in FIG. 5, a user info field may comprise an AID12 subfield, an RU allocation subfield, reserved bits, and a PS 160 subfield. The AID12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160 MHz, an 80+80 Mhz channel, or a 320 MHz channel.

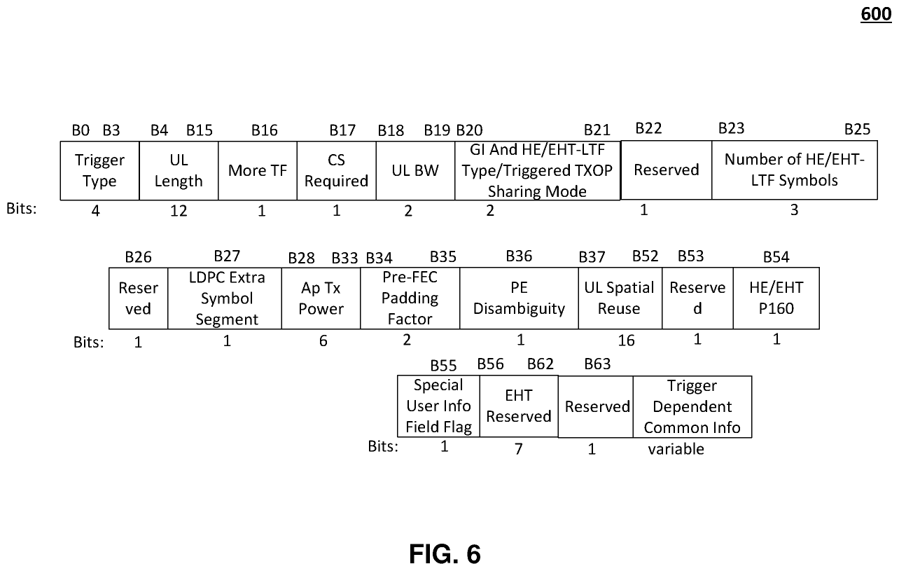

FIG. 6 illustrates an example Common Info field 600. Common Info field 600 may be an embodiment of the Common Info field of trigger frame 400 or MU-RTS trigger frame 500, for example. As shown in FIG. 6, Common Info field 600 may include a Trigger Type subfield, a UL Length subfield, a More TF subfield, a CS required subfield, a UL BW subfield, a GI and HE/EHT-LTF Type/Triggered TXS Mode subfield, a first Reserved subfield, a Number of HE/EHT-LTF Symbols subfield, a second Reserved subfield, an LDPC Extra Symbol Segment subfield, an AP Tx Power subfield, a Pre-FEC Padding Factor subfield, a PE Disambiguity subfield, an UL Spatial Reuse subfield, a third Reserved subfield, an HE/EHT P160 subfield, a Special User Info Field Flag subfield, an EHT Reserved subfield, a fourth Reserved subfield, and a Trigger Dependent Common Info subfield. The Trigger Type subfield, UL Length subfield, More TF subfield, CS required subfield, UL BW subfield, GI and HE-LTF Type/Triggered TXS Mode subfield, first Reserved subfield, Number of HE/EHT-LTF Symbols subfield, second Reserved subfield, LDPC Extra Symbol Segment subfield, AP Tx Power subfield, Pre-FEC Padding Factor subfield, PE Disambiguity subfield, UL Spatial Reuse subfield, third Reserved subfield, HE/EHT P160 subfield, Special User Info Field Flag subfield, EHT Reserved subfield, fourth Reserved subfield, and Trigger Dependent Common Info subfield may have the same content and interpretation as corresponding subfields of an EHT variant Common Info field defined in the IEEE 802.11be draft amendment (“IEEE P802.11be/D3.1, March 2023”).

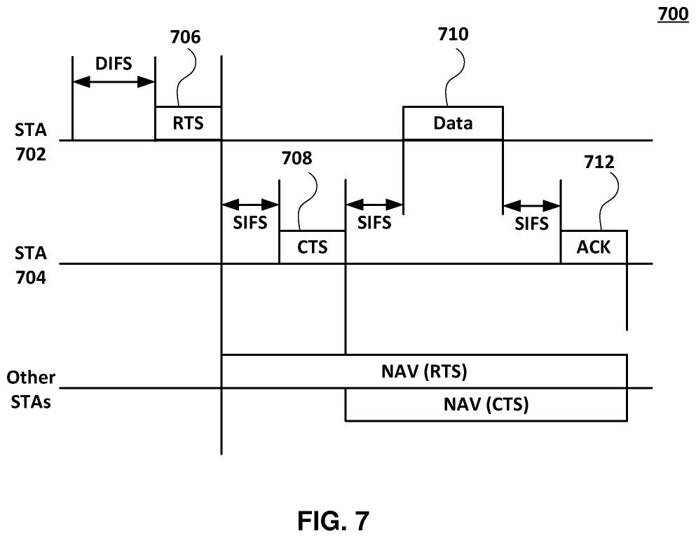

FIG. 7 illustrates an example 700 of a Request-to-Send (RTS)/Clear-to-Send (CTS) procedure. Example 700 may be an example according to the RTS/CTS procedure as defined in section 10.3.2.9 of the IEEE 802.11 standard draft “IEEE P802.11-REVme™/D3.0, April 2023.” As shown in FIG. 7, example 700 may include STAs 702 and 704. Other STAs of the same BSS may also be within communication range of STAs 702 and 704.

In an example, STA 702 may transmit an RTS frame 706 to STA 704. STA 702 may transmit RTS frame 706 to protect from hidden STA(s) the transmission of a data frame 710 that STA 702 intends to transmit. RTS frame 706 may include a Duration/ID field. The Duration/ID field may be set to the time, in microseconds, required to transmit data frame 710, plus one CTS frame, plus one ACK frame (if required), plus three SIFS (Short Interframe Spacing) periods.

In an example, STA 704 may respond to RTS frame 706 by transmitting a CTS frame 708 to STA 702. CTS frame 708 may be transmitted one SIFS period after RTS frame 706. STA 704 may respond to RTS frame 706 when RTS frame 706 is addressed to STA 704 and after considering the NAV, unless the NAV was set by a frame originating from STA 702. STA 704 may respond to the RTS frame 706 when RTS frame 706 is addressed to STA 704 and if the NAV indicates idle. For a non-S1G STA, the NAV indicates idle when the NAV count is 0 or when the NAV count is non-zero but a nonbandwidth signaling TA obtained from a TA field of RTS frame 706 matches a saved TXOP holder address. For an S1G STA, the NAV indicates idle when both the NAV and RID (response indication deferral) counters are 0 or when either the NAV or RID counter is non-zero but the TA field of RTS frame 706 matches the saved TXOP holder address.

STA 704 may set an RA field of CTS frame 708 to a nonbandwidth signaling TA obtained from the TA field of RTS frame 706. STA 704 may set a Duration field of CTS frame 708 based on the Duration/ID field of RTS frame 706, namely as equal to the value of the Duration/ID field of RTS frame 706, adjusted by subtracting the time required to transmit CTS frame 708 and one SIFS period.

Upon receiving CTS frame 708, STA 702 may wait one SIFS period before transmitting data frame 710. STA 704 may transmit an ACK frame 712 in response to data frame 710. STA 704 may transmit ACK frame 712 one SIFS after receiving data frame 710.

As shown in example 700, other STAs within communication range of STAs 702 and 704, and belonging to the same BSS, may set their NAVs according to RTS frame 706 and/or CTS frame 708. For example, a STA receiving RTS frame 706 may set its NAV based on the Duration/ID field of RTS frame 706. Another STA receiving CTS frame 708 may set its NAV based on the Duration field of CTS frame 708. As such, the other STAs may not access the channel using EDCA until the end of transmission of ACK frame 712.

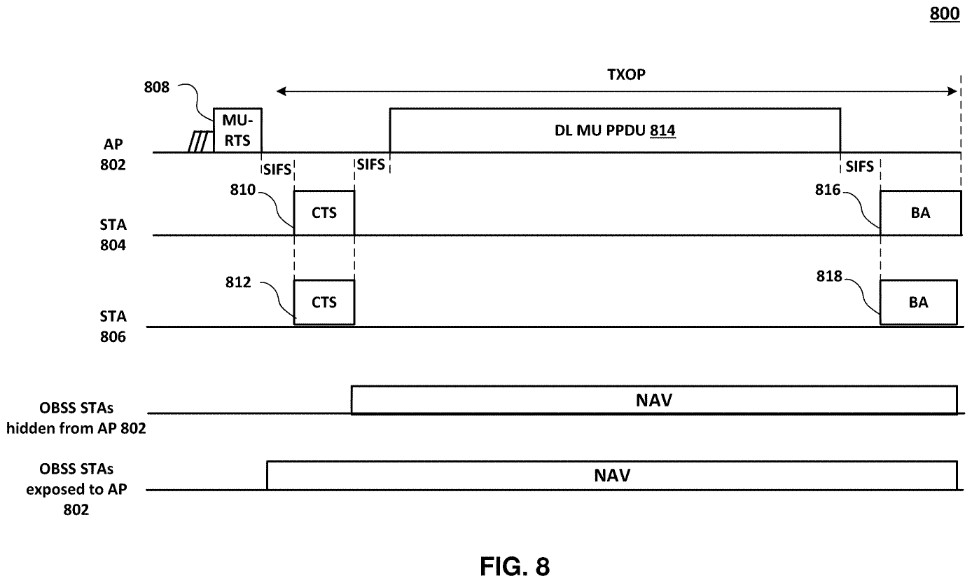

FIG. 8 is an example 800 that illustrates a multi-user Request-to-Send (MU-RTS)/Clear-to-Send (CTS) procedure. Example 800 may be an example according to the MU-RTS/CTS procedure as defined in section 26.2.6 of the IEEE 802.11 standard draft. As shown in FIG. 8, example 800 may include an AP 802 and STAs 804 and 806. STAs 804 and 806 may be associated with AP 802. For the purpose of illustration, example 800 also illustrates STAs of an overlapping basic service set (OBSS) relative to the BSS of AP 802 (OBSS STAs). The OBSS STAs, as shown in FIG. 8, may be hidden from AP 802 (outside of the communication range of AP 802) or exposed to AP 802 (within the communication range of AP 802).

In example 800, AP 802 wishes to transmit a downlink (DL) multi-user (MU) PPDU 814 to STAs 804 and 806. DL MU PPDU 814 may comprise data for each of STAs 804 and 806. DL MU PPDU 814 may occupy a plurality of channels (e.g., 20 MHz channels). Each channel of the plurality of channels may carry the data for a respective STA (e.g., STA 804, STA 806) served by DL MU PPDU 814.

As shown in FIG. 8, to protect the transmission of DL MU PPDU 814 to STAs 804 and 806 from interference by OBSS STAs hidden from AP 802, AP 802 may use the MU-RTS/CTS procedure to initiate a TXOP and to protect the TXOP frame exchange sequence. AP 802 may initiate the TXOP by transmitting an MU-RTS trigger frame 808 that solicits simultaneous CTS frame transmissions from STAs 804 and 806.

MU-RTS trigger frame 808 may have a format as illustrated by MU-RTS trigger frame 500 illustrated in FIG. 5. As such, MU-RTS trigger frame 808 may comprise a frame control field, a duration field, an RA field, a TA field, a common info field, one or more user info fields, a padding field, and an FCS field. The duration field may be set to the time, in microseconds, required to transmit DL MU PPDU 814, plus the time required to transmit one CTS frame, one ACK frame (if required), and three SIFS periods.

The one or more user info fields correspond respectively to the one or more STAs solicited by the MU-RTS trigger frame. In example 800, MU-RTS trigger frame 808 may comprise a user info field for each of STAs 804 and 806 indicating that a CTS frame is solicited from each of STAs 804 and 806. As shown in FIG. 8, a user info field may comprise an AID12 subfield, an RU allocation subfield, reserved bits, and a PS 160 subfield. The AID12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160 MHz, an 80+80 Mhz channel, or a 320 MHz channel.

AP 802 may send MU-RTS trigger frame 808 in a PPDU that occupies one or more channels (e.g., 20 MHz channels). In an example, for each channel occupied by the PPDU that carries MU-RTS trigger frame 808, AP 802 may request at least one non-AP STA to send a CTS frame that occupies that channel. In an example, AP 802 may not request that a non-AP STA send a CTS frame that occupies a channel that is not occupied by the PPDU carrying MU-RTS trigger frame 808.

After transmitting MU-RTS trigger frame 808, AP 802 may wait for a CTSTimeout interval of aSIFSTime+aSlotTime+aRxPHYStartDelay that begins when a MAC layer of AP 802 receives a PHYTXEND.confirm primitive for transmitted MU-RTS trigger frame 808. If the MAC layer does not receive a PHY-RXEARLYSIG.indication or a PHY-RXSTART.indication primitive during the CTSTimeout interval, AP 802 may conclude that the transmission of MU-RTS trigger frame 808 has failed, and, if MU-RTS trigger frame 808 initiated a TXOP, AP 802 may invoke its backoff procedure. If the MAC layer receives a PHY-RXEARLYSIG.indication or a PHY-RXSTART.indication primitive during the CTSTimeout interval, then the MAC layer may wait for the corresponding PHY-RXEND.indication primitive to determine whether transmission of MU-RTS trigger frame 808 was successful. The receipt of a CTS frame from any non-AP STA addressed by MU-RTS trigger frame 808 before the PHY-RXEND.indication primitive shall be interpreted as the successful transmission of MU-RTS trigger frame 808, permitting the frame exchange sequence to continue. The receipt of any other type of frame shall be interpreted as a failure of the transmission of MU-RTS trigger frame 808. AP 802 may process the received frame and, if MU-RTS trigger frame 808 initiated a TXOP, AP 802 shall invoke its backoff procedure at the PHY-RXEND.indication primitive.

In example 800, on receiving MU-RTS trigger frame 808, STAs 804 and 806 respond by transmitting respectively CTS frames 810 and 812 to AP 802. In an example, STAs 804 and 806 begin the transmission of CTS frames 810 and 812, respectively, at the SIFS time boundary after an end of a received PPDU comprising MU-RTS trigger frame 808. In an example, STA 804 (or STA 806) responds to MU-RTS trigger frame 808 with a CTS frame when the following conditions are met: MU-RTS trigger frame 808 comprises a user info field addressed to the STA (the AID12 subfield of the user info field is equal to the 12 LSBs of the AID of the STA) and MU-RTS trigger frame 808 is sent by an AP with which the STA is associated; and the UL MU CS condition indicates that the medium is idle as described in section 26.5.2.5 (UL MU CS mechanism) of the IEEE 802.11 standard (“IEEE P802.11-REVme™/D3.0, April 2023”). Otherwise, if one of the conditions is not met, STA 804 (or STA 806) does not send a CTS frame to AP 802.

In an example, STAs 804 and 806 may set an RA field of respectively CTS frames 810 and 812 to a TA obtained from the TA field of MU-RTS trigger frame 808. In an example, STAs 804 and 806 may set a duration field of respectively CTS frames 810 and 812 based on the duration field of MU-RTS trigger frame 808, namely as equal to the value of the duration field of MU-RTS trigger frame 808, adjusted by subtracting the time required to transmit respectively CTS frames 810 and 812 and one SIFS period.

OBSS STAs exposed to AP 802 may receive MU-RTS trigger frame 808 due to being within the communication range of AP 802. In an example, as shown in FIG. 8, on receiving MU-RTS trigger frame 808, OBSS STAs exposed to AP 802 set their respective NAVs based on the duration field of MU-RTS trigger frame 808. As such, the OBSS STAs exposed to AP 802 may not access the wireless medium for the duration of the TXOP initiated by AP 802.

OBSS STAs hidden from AP 802 do not receive MU-RTS trigger frame 808 due to being outside the communication range of AP 802. However, in an example, as shown in FIG. 8, some of the OBSS STAs hidden from AP 802 may receive CTS frame 810 and/or CTS frame 812 and may set their respective NAVs based on the duration field of CTS frame 810 and/or CTS frame 812. As such, some of the OBSS STAs hidden from AP 802 may also not access the wireless medium for the duration of the TXOP initiated by AP 802.

On receiving CTS frame 810 and/or CTS frame 812, AP 802 may wait one SIFS period before transmitting DL MU PPDU 814. On receiving DL MU PPDU 814, STAs 804 and 806 may respond by transmitting respective BlockAck (BA) frames 816 and 818 to AP 802.

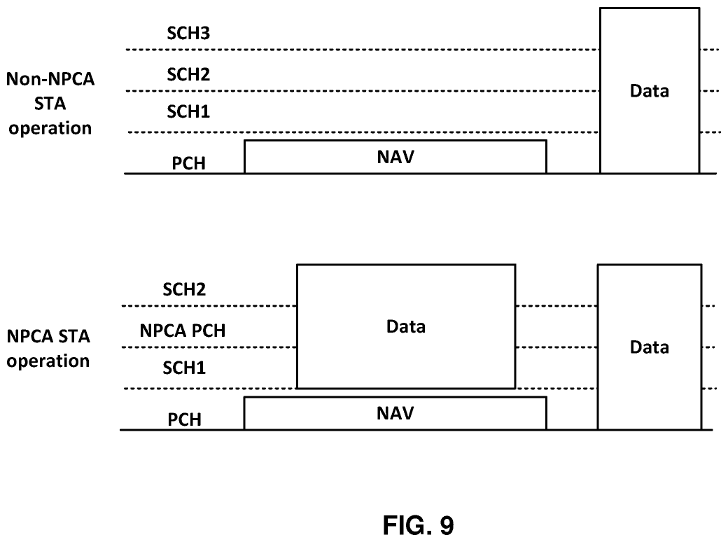

It is envisioned in future IEEE 802.11 standards that a STA (AP STA or non-AP STA) may access a non-primary channel to communicate with another STA. Such operation may be referred to as non-primary channel access (NPCA) operation. Specifically, in addition to a default primary channel (which is used by all STAs in the BSS and via which the AP transmits management frames), the STA may have one or more secondary channels considered as NPCA primary channels. The STA may transmit or receive on a channel that includes an NPCA primary channel but that does not necessarily include the primary channel (e.g., when the primary channel is unavailable). The STA may maintain a NAV for an NPCA primary channel independent of the NAV associated with the primary channel. FIG. 9 shows an example that illustrates non-primary channel access (NPCA) operation. For the purpose of illustration, NPCA operation is contrasted with single primary channel (non-NPCA STA) operation. As shown in FIG. 9, the STA may be capable of operating over a plurality of channels. According to non-NPCA operation, the plurality of channels may include a primary channel (PCH), a first secondary channel (SCH1), a second secondary channel (SCH2), and a third secondary channel (SCH2). According to NPCA operation, the same channels may include a primary channel (PCH), a first secondary channel (SCH1), an NPCA primary channel (NPCA PCH), and a second secondary channel (SCH2). It is noted that the position of the NPCA primary channel may or may not be as shown in the example of FIG. 9. For example, the NPCA primary channel may correspond to SCH1.

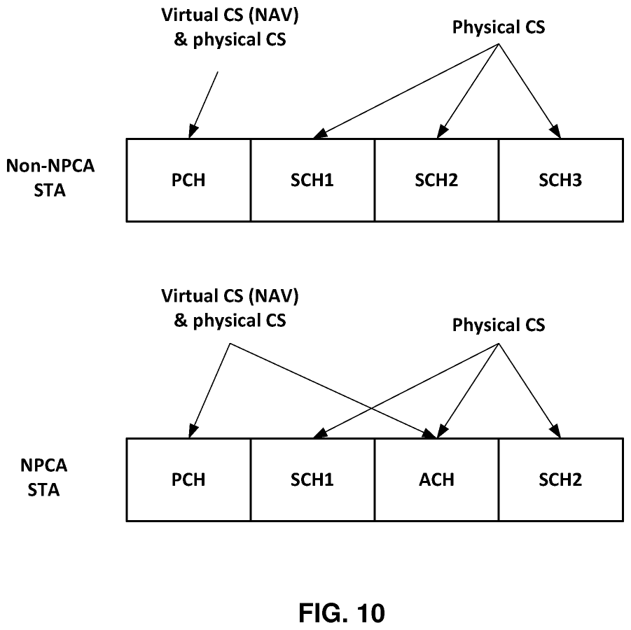

In an implementation, as shown in FIG. 10, in non-NPCA operation, a virtual carrier sense (CS) function (e.g., NAV) may be associated with only the PCH. Secondary channels may have only a physical CS function (e.g., energy detection) associated with them, which may be performed only when contending for transmission on the PCH. As such, as shown in FIG. 9, the STA may only transmit on a channel that includes the PCH (e.g., PCH, PCH+SCH1, PCH+SCH1+SCH2, PCH+SCH1+SCH2+SCH3) and only when the NAV associated with the PCH is zero (and the physical CS function indicates “channel idle” for all channels being used).

In contrast, as shown in FIG. 10, in NPCA operation, a virtual CS function (e.g., NAV) may be associated with multiple channels (e.g., PCH and NPCA PCH). As such, as shown in FIG. 9, the STA may transmit on channels that do not include the PCH but that include the NPCA PCH (e.g., NPCA PCH, NPCA PCH+SCH1, NPCA PCH+SCH2) if the NAV associated with the NPCA PCH is zero (and the physical CS indicates “channel idle” for all channels being used). In an implementation, the STA may also transmit on channels that do not include the PCH but that include the NPCA PCH (e.g., NPCA PCH, NPCA PCH+SCH1, NPCA PCH+SCH2) if the STA detects that the NPCA PCH is idle using physical CS for at least a medium synchronization duration.

In implementations, the STA may perform physical and/or virtual CS functions (herein referred to as CS or CCA) on multiple channels (e.g., PCH and NPCA PCH). If the PCH is busy (non-zero NAV or CCA indicates “channel busy”), the STA may use the NPCA PCH for transmission if the NPCA PCH is idle (zero NAV and CCA indicates “channel idle”).

In an implementation, the STA may perform CS in parallel on multiple channels, including the PCH and the NPCA PCH. Such a STA is referred to herein as a concurrent CCA NPCA STA (such a STA may also be referred to as a concurrent CCA multiple primary channel (MPC) STA or a Type 1 STA). Because of its concurrent CCA capability, a concurrent CCA NPCA STA is capable of medium synchronization simultaneously on multiple channels (e.g., PCH and NPCA PCH). Medium synchronization on a channel (e.g., PCH or NPCA PCH) may be performed by detecting a frame that includes NAV information or by listening to the channel for at least a medium synchronization duration and finding the channel idle throughout the medium synchronization duration. An NPCA STA that does not support this capability may perform CS on a single channel at a time. In an implementation, an NPCA STA may perform CS on the PCH by default, and when the PCH is found busy, the STA may perform CS on the NPCA PCH. Such a STA is referred to herein as a non-concurrent CCA NPCA STA (such a STA may also be referred to as a non-concurrent CCA MPC STA or a Type 2 STA). In contrast to the concurrent CCA NPCA STA, a non-concurrent CCA NPCA STA may only synchronize to the NPCA PCH after the PCH is found busy. Hence, it may need to listen to the channel for at least a medium synchronization duration (if it does not receive any frame that includes NAV information) before it is able to transmit.

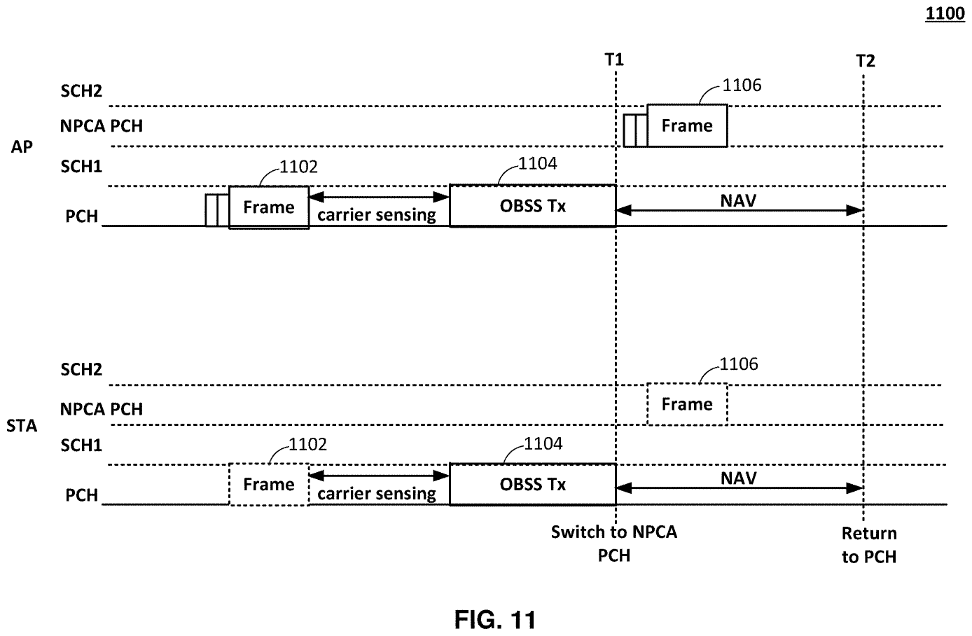

FIG. 11 shows an example 1100 that illustrates an NPCA operation. As shown in FIG. 11, example 1100 includes an AP and a STA associated with the AP. The AP and the STA may both support NPCA operation and may operate over a plurality of channels, including a primary channel (PCH), an NPCA primary channel (NPCA PCH), a first secondary channel (SCH1), and a second secondary channel (SCH2).

Example 1100 may begin with the AP transmitting a frame 1102 on the PCH. Frame 1102 may indicate a medium synchronization duration for the NPCA PCH. The medium synchronization duration of a channel indicates a minimum duration that a STA must listen to the channel before the STA is able to transmit on the channel (if the STA does not receive via the channel before the end of the medium synchronization duration a frame that indicates NAV information). Frame 1102 may be a management frame, such as a beacon frame, for example.

Subsequently, while the AP and STA operate on the PCH, transmission of a frame 1104 from an OBSS may begin on the PCH. The AP and the STA may detect frame 1104 on the PCH. In an implementation, the AP and STA may be configured to set a NAV associated with the PCH based on receiving frame 1104 on the PCH. Frame 1104 may indicate a transmission (of one or more frames including frame 1104) on the PCH. A duration of the transmission on the PCH may be provided by a duration field of frame 1104, a transmission opportunity (TXOP) duration field of an inter-BSS PPDU comprising frame 1104, or a length field of the inter-BSS PPDU. The AP and STA may set their NAVs for the PCH based on the duration of the OBSS transmission on the PCH (hereinafter, OBSS NAV duration or OBSS TXOP duration).

In accordance with NPCA operation, on receiving an inter-BSS PPDU and obtaining the OBSS NAV duration, the AP and the STA may be configured to switch to the NPCA PCH for the OBSS NAV duration. In an example, the AP and the STA may switch to the NPCA PCH at time T1 as shown in example 1100. Here, time T1 may correspond to the time for switching from the PCH to the NPCA PCH after obtaining the OBSS NAV duration. The AP and STA may be configured to finish transmitting on the NPCA PCH before an end of the OBSS NAV duration and to return to the PCH by the end of the OBSS NAV duration, by time T2, as shown in example 1100. Here, time T2 may correspond to the time for switching from the NPCA PCH to the PCH by the end of OBSS NAV duration.

In an implementation, after switching to the NPCA PCH, the AP and STA may start a “MediumSyncDelay” timer for the medium synchronization duration of the NPCA PCH (e.g., as indicated in frame 1102). In example 1100, the AP may be a concurrent CCA STA capable of concurrent CS on both the PCH and the NPCA PCH. As such, provided that the NPCA PCH is idle, the AP may access the NPCA PCH, without waiting for expiration of the “MediumSyncDelay” timer, to transmit a frame 1106 on the NPCA PCH. In an example, the STA may be a non-concurrent CCA STA. On switching to the NPCA PCH, the STA may not be aware of whether a transmission is ongoing on the NPCA PCH. The STA may thus be configured to sense the NPCA PCH until the “MediumSyncDelay” timer expires before attempting to access the NPCA PCH. However, the STA may acquire medium synchronization on the NPCA PCH before expiration of the “MediumSyncDelay” timer if the STA receives a frame indicating NAV information on the NPCA PCH. For example, the STA may acquire medium synchronization on the NPCA PCH on receiving frame 1106 from the AP. The STA may reset the “MediumSyncDelay” timer to zero and may then proceed to access the NPCA PCH, after performing a random backoff, to transmit a frame (not shown in FIG. 11) on the NPCA PCH.

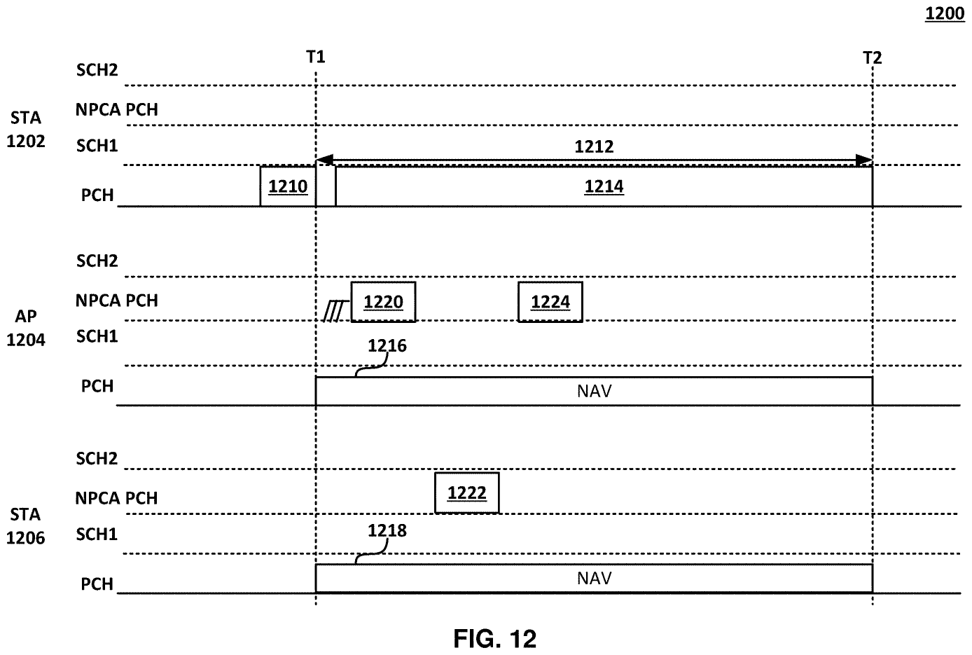

FIG. 12 shows another example 1200 that illustrates NPCA operation. As shown in FIG. 12, example 1200 includes STA 1202, AP 1204, and STA 1206. AP 1204 and STA 1206 may belong to the same BSS. STA 1202 may belong to a different BSS than AP 1204 and STA 1206. In an example, STA 1202 may be an AP STA or a non-AP STA. In an example, AP 1204 may be an AP STA, and STA 1206 may be a non-AP STA. In an example, where AP 1204 is an AP STA and STA 1206 is a non-AP STA, STA 1206 may be associated with AP 1204. In an example, AP 1204 and STA 1206 may support NPCA operation and may operate over a plurality of channels, including a primary channel (PCH), an NPCA primary channel (NPCA PCH), a first secondary channel (SCH1), and a second secondary channel (SCH2).

As shown in FIG. 12, example 1200 may begin with STA 1202 transmitting a frame 1210 on the PCH. By transmitting frame 1210, STA 1202 may obtain a TXOP on the PCH. Frame 1210 may be comprised in a PPDU comprising a TXOP duration field. The TXOP duration field may indicate a TXOP duration 1212. TXOP duration 1212 may indicate a duration that starts by the end of frame 1210 (e.g., starting at a time T1) and that ends at a time T2 as shown in FIG. 12. After transmitting frame 1210, STA 1202 may communicate with its associated STAs via the PCH within TXOP duration 1212. In an example, STA 1202 may perform uplink and/or downlink communications as illustrated with a frame exchange 1214. In example 1200, frame exchange 1214 may extend to the end of TXOP duration 1212.

In an example, on receiving frame 1210, AP 1204 may determine that frame 1210 is comprised in an inter-BSS PPDU (OBSS PPDU). As discussed above in relation to FIG. 11 and in accordance with NPCA operation, AP 1204 may set a NAV 1216 for the PCH based on TXOP duration 1212 and may switch to the NPCA PCH for TXOP duration 1212 (OBSS NAV duration for AP 1204). In example 1200, AP 1204 may switch to the NPCA PCH at a time T1. After switching to the NPCA PCH, AP 1204 may be involved in uplink and/or downlink communications with its associated STAs. In example 1200, after switching to the NPCA PCH, uplink communications between AP 1204 and its associated STAs (e.g., STA 1206) may be performed via only triggered-based (TB) physical layer (PHY) protocol data unit (PPDU) transmission. Accordingly, after switching to the NPCA PCH, a STA associated with AP 1204 (e.g., STA 1206) may only transmit a frame to AP 1204 in response to a trigger frame from AP 1204. In other words, after switching to the NPCA PCH, a STA associated with AP 1204 (e.g., STA 1206) may not initiate a transmission if not triggered by AP 1204. Allowing only triggered uplink communications on the NPCA PCH may facilitate AP 1204 obtaining control of the NPCA PCH, especially when a large number of STAs contend for the NPCA PCH and the STAs have asynchronous switching times due to different implementations.

In an example, on receiving frame 1210, STA 1206 may determine that frame 1210 is comprised in an inter-BSS PPDU (OBSS PPDU). Based on supporting/enabling NPCA operation, STA 1206 may set a NAV 1218 for the PCH based on TXOP duration 1212 and may switch to the NPCA PCH for TXOP duration 1212 (OBSS NAV duration for STA 1206). In example 1200, STA 1206 may switch to the NPCA PCH at a time T1. After switching to the NPCA PCH, based on being associated with AP 1204 and being configured to perform only TB PPDU transmission on the NPCA PCH after switching to the NPCA PCH, STA 1206 may be involved in downlink communications and/or trigger based uplink communications with AP 1204. As such, STA 1206 does not initiate a TXOP on the NPCA PCH after switching from the PCH.

In an example, after switching to the NPCA PCH, AP 1204 may start a “MediumSyncDelay” timer for the medium synchronization duration of the NPCA PCH, and if the NPCA PCH is idle (at/after expiration of the MediumSyncDelay timer), AP 1204 may access the NPCA PCH to transmit a frame on the NPCA PCH. In example 1200, AP 1204 may transmit a frame 1220 to STA 1206. In an example, frame 1220 may be a trigger frame. In an example, AP 1204 may have the buffered traffic information of STA 1206 in an earlier frame exchange (not shown in FIG. 12). As such, AP 1204 may transmit frame 1220 to trigger STA 1206 to transmit its buffered traffic to AP 1204. In an example, before transmitting frame 1220, AP 1204 and STA 1206 may perform a request-to-send (RTS) clear-to-send (CTS) frame exchange (not shown in FIG. 12). In example 1200, in response to frame 1220, STA 1206 may transmit a frame 1222. In an example, frame 1222 may be a PPDU. In an example, PPDU may be a TB PPDU. On receiving frame 1222, AP 1204 may transmit a frame 1224. In an example, frame 1224 may be a BlockAck (BA) frame. In an example (not shown in FIG. 12), AP 1204 may further perform triggered based uplink communications and/or downlink communications with STA 1206 and/or other associated STAs. In an example, AP 1204 and STA 1206 switch back to the PCH by the end of TXOP duration 1212 (e.g., by time T2).

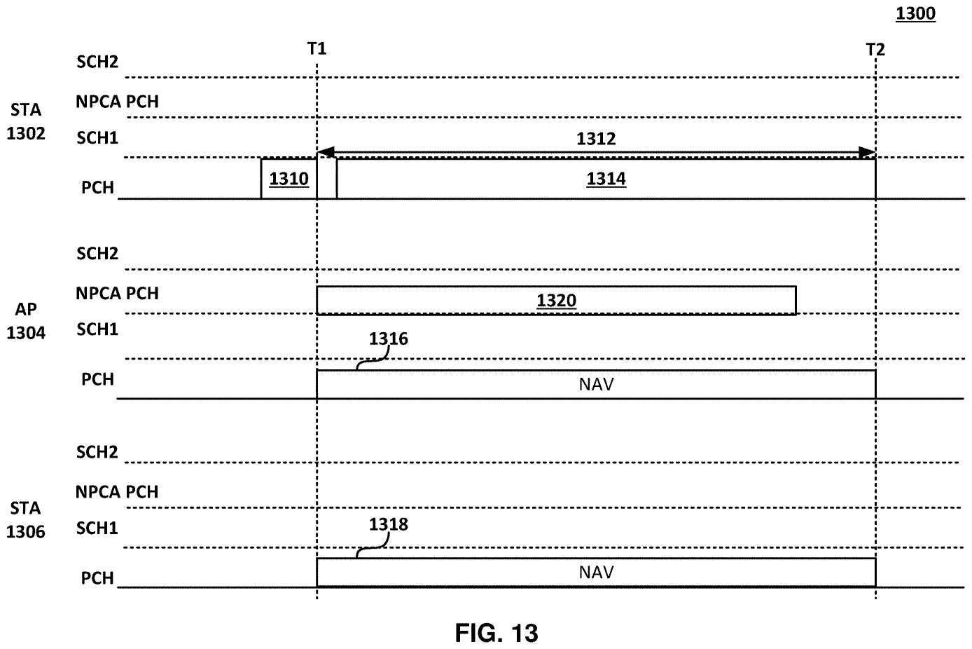

FIG. 13 illustrates an example 1300 that highlights a problem that may arise in existing NPCA operation. As shown in FIG. 13, example 1300 includes STA 1302, AP 1304, and STA 1306. AP 1304 and STA 1306 may belong to the same BSS. STA 1302 may belong to a different BSS than AP 1304 and STA 1306. In an example, STA 1302 may be an AP STA or a non-AP STA. In an example, AP 1304 may be an AP STA, and STA 1306 may be a non-AP STA. In an example, where AP 1304 is an AP STA and STA 1306 is a non-AP STA, STA 1306 may be associated with AP 1304. In an example, AP 1304 and STA 1306 may support NPCA operation and may operate over a plurality of channels, including a primary channel (PCH), an NPCA primary channel (NPCA PCH), a first secondary channel (SCH1), and a second secondary channel (SCH2).

As shown in FIG. 13, example 1300 may begin with STA 1302 transmitting a frame 1310 on the PCH. By transmitting frame 1310, STA 1302 may obtain a TXOP on the PCH. Frame 1310 may be comprised in a PPDU comprising a TXOP duration field. The TXOP duration field may indicate a TXOP duration 1312. TXOP duration 1312 may indicate a duration that starts by the end of frame 1310 (e.g., starting at a time T1) and that ends at a time T2 as shown in FIG. 13. After transmitting frame 1310, STA 1302 may communicate with its associated STAs via the PCH within TXOP duration 1312. In an example, STA 1302 may perform uplink and/or downlink communications as illustrated with a frame exchange 1314. In example 1300, frame exchange 1314 may extend to the end of TXOP duration 1312.

In an example, on receiving frame 1310, AP 1304 may determine that frame 1310 is comprised in an inter-BSS PPDU (OBSS PPDU). As discussed above in relation to FIG. 11 and in accordance with NPCA operation, AP 1304 may set a NAV 1316 for the PCH based on TXOP duration 1312 and may switch to the NPCA PCH for TXOP duration 1312 (OBSS NAV duration for AP 1304). In example 1300, AP 1304 may switch to the NPCA PCH at a time T1. After switching to the NPCA PCH, AP 1304 may be involved in uplink and/or downlink communications with its associated STAs. In example 1300, after switching to the NPCA PCH, uplink communications between AP 1304 and its associated STAs (e.g., STA 1306) may be performed via only triggered-based (TB) physical layer (PHY) protocol data unit (PPDU) transmission. Accordingly, after switching to the NPCA PCH, a STA associated with AP 1304 (e.g., STA 1306) may only transmit a frame to AP 1304 in response to a trigger frame from AP 1304. In other words, after switching to the NPCA PCH, a STA associated with AP 1304 (e.g., STA 1306) may not initiate a transmission if not triggered by AP 1304. Allowing only triggered uplink communications on the NPCA PCH may facilitate AP 1304 obtaining control of the NPCA PCH, especially when a large number of STAs contend for the NPCA PCH and the STAs have asynchronous switching times due to different implementations.

In an example, on receiving frame 1310, STA 1306 may determine that frame 1310 is comprised in an inter-BSS PPDU (OBSS PPDU). Based on supporting/enabling NPCA operation, STA 1306 may set a NAV 1318 for the PCH based on TXOP duration 1312 and may switch to the NPCA PCH for TXOP duration 1312 (OBSS NAV duration for STA 1306). In example 1300, STA 1306 may switch to the NPCA PCH at a time T1. After switching to the NPCA PCH, based on being associated with AP 1304 and being configured to perform only TB PPDU transmission on the NPCA PCH after switching to the NPCA PCH, STA 1306 may be involved in downlink communications and/or trigger based uplink communications with AP 1304. As such, STA 1306 does not initiate a TXOP on the NPCA PCH PCH after switching from the PCH.

In an example, after switching to the NPCA PCH, AP 1304 may start a “MediumSyncDelay” timer for the medium synchronization duration of the NPCA PCH, and if the NPCA PCH is idle (at/after expiration of the MediumSyncDelay timer), AP 1304 may access the NPCA PCH to transmit a frame on the NPCA PCH. In example 1300, after expiration of the MediumSyncDelay timer, AP 1304 may detect that the NPCA PCH is not idle during a busy duration 1320. As such, AP 1304 may not access the NPCA PCH to transmit a frame during busy duration 1320. In an example, busy duration 1320 may be due to another OBSS transmission on the NPCA PCH, where AP 1304 may detect the OBSS transmission. In another example, busy duration 1320 may be due to AP 1304 contending for the NPCA PCH but not obtaining control of the channel. In another example, busy duration 1320 may be due to a busy channel condition for AP 1304. As such, AP 1304 may not perform downlink communications and/or trigger its associated STAs (e.g., STA 1306) for uplink communications during busy duration 1320.

In an example, STA 1306 may not detect the NPCA PCH to be idle during busy duration 1320. In an example, STA 1306 may be outside the communication range of the OBSS transmission due to which AP 1304 detects the NPCA PCH as not idle. In another example, STA 1306 may not know about the busy channel condition for AP 1304. However, despite detecting an idle channel on the NPCA PCH and having buffered traffic for AP 1304, STA 1306 may not initiate transmission of an uplink PPDU to AP 1304 without being triggered by AP 1304. As such, STA 1306 may not initiate an uplink transmission to AP 1304 until the end of busy duration 1320. When STA 1306 has low latency traffic to transmit to AP 1304, the low latency traffic may be delayed and may be discarded or lost.

Embodiments of the present disclosure, as further described below, address the above-discussed problem of existing technologies. In an aspect, a STA switches from a primary channel (PCH) to a non-primary channel access (NPCA) PCH and sets a timer based on a duration, where the duration indicates a time period during which the STA, while operating on a NPCA PCH, is not allowed/configured to initiate a transmission opportunity (TXOP) on the NPCA PCH. In an embodiment, the STA is informed of the duration before switching. In an embodiment, the switching occurs at a first time, and a start time of the time period may be equal to the first time. In another embodiment, the STA receives from the AP and via the NPCA PCH, a first frame indicating no more downlink data for the STA. The start time of the time period may be equal to a reception time of the first frame. In another embodiment, the STA is informed of the duration after switching. In an embodiment, the STA receives from the AP and via the NPCA PCH, a first frame informing the STA of the duration. The start time of the time period may be equal to a reception time of the first frame. In an embodiment, the STA initiates a first TXOP on the NPCA PCH on condition that a value of the timer is zero (e.g., the timer is expired). As such, in embodiments, a STA that switches from the PCH to the NPCA PCH may operate in a triggered-only uplink transmission mode during a time period after switching from the PCH to the NPCA PCH and may be allowed to initiate a TXOP on the NPCA PCH (perform an untriggered uplink transmission on the NPCA PCH) after the time period. As such, the STA may access the NPCA PCH to transmit any buffered (e.g., low latency) traffic to the AP after the time period, without waiting for a trigger frame from the AP. This addresses the above-described problem in which the AP may be prevented from triggering the STA for uplink transmissions to the AP.

In another aspect, the STA receives from the AP a beacon frame indicating a value of a multi-user (MU) enhanced distributed channel access (EDCA) timer. In an embodiment, the MU EDCA timer indicates a duration of time during which the first STA uses MU EDCA parameters for channel access. In an embodiment, the STA receives the beacon frame on the PCH. In an embodiment, the STA starts the MU EDCA timer. In an embodiment, the STA determines that a PPDU being received via the PCH comprises an inter-BSS PPDU. In an embodiment, the STA switches from the PCH to the NPCA PCH, based on the determining. In an embodiment, the STA sets an arbitration interframe space number (AIFSN) for an access category (AC) to zero based on the switching. In an embodiment, the STA suspends initiating a TXOP on the NPCA PCH (or suspends an EDCA function (EDCAF) for the AC, where the EDCAF is logical function that determines, using EDCA, when a frame associated with the AC is permitted/allowed to be transmitted via the wireless medium) until the MU EDCA timer reaches a value of zero, based on the AIFSN being equal to zero. In an embodiment, the STA initiates a TXOP on the NPCA PCH after the MU EDCA timer reaches the value of zero. As such, the STA being able to initiate a TXOP after the MU EDCA timer reaching the value of zero may help the AP initiate a TXOP on the NPCA PCH before any of the associated STAs of the AP.

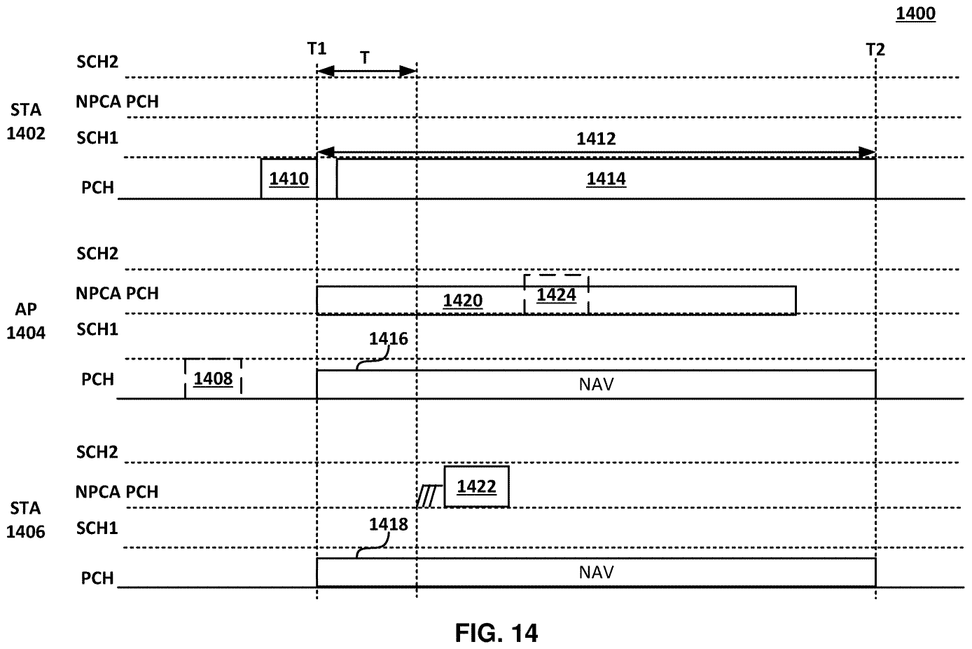

FIG. 14 shows an example 1400 that illustrates an example NPCA operation according to an embodiment. As shown in FIG. 14, example 1400 includes STA 1402, AP 1404, and STA 1406. AP 1404 and STA 1406 may belong to the same BSS. STA 1402 may belong to a different BSS than AP 1404 and STA 1406. In an example, STA 1402 may be an AP STA or a non-AP STA. In an embodiment, AP 1404 may be an AP STA, and STA 1406 may be a non-AP STA. In an embodiment, where AP 1404 is an AP STA and STA 1406 is a non-AP STA, STA 1406 may be associated with AP 1404. In an embodiment, AP 1404 and STA 1406 may support NPCA operation and may operate over a plurality of channels, including a primary channel (PCH), an NPCA primary channel (NPCA PCH), a first secondary channel (SCH1), and a second secondary channel (SCH2).

As shown in FIG. 14, example 1400 may begin with AP 1404 transmitting a frame 1408 to STA 1406 on the PCH. In an embodiment, frame 1408 may comprise a management frame, an action frame, a control frame, a quality of service (QoS) null frame, or a QoS data frame. In an embodiment, where frame 1408 comprises the management frame, the management frame may comprise a beacon frame. In an embodiment, frame 1408 may indicate a duration. In an embodiment, the duration indicates a time period during which STA 1406, while operating on the NPCA PCH, is not allowed/configured to initiate a TXOP on the NPCA PCH. In an embodiment, the duration indicates a time period during which STA 1406 is not allowed/configured to transmit a non-trigger based (non-TB) physical layer protocol data unit (PPDU) to the AP via the NPCA PCH. In another embodiment, the duration indicates a time period during which STA 1406 does not transmit a non-TB PPDU to the AP via the NPCA PCH. In another embodiment, the duration indicates a time period during which STA 1406 is not allowed to transmit a non-TB PPDU to the AP via the NPCA PCH but is allowed to transmit a TB PPDU to the AP via the NPCA PCH. In another embodiment, the duration may be a value of a multi-user (MU) enhanced distributed channel access (EDCA) timer. In an embodiment, the MU EDCA timer may be a field comprised in MU EDCA parameters. In an embodiment, the MU EDCA timer indicates a duration of time during which STA 1406 uses the MU EDCA parameters. In an embodiment, the MU EDCA timer starts after a TB PPDU transmitted by STA 1406 in response to a trigger frame transmitted by AP 1404, e.g., if an immediate acknowledgement is not needed after the TB PPDU. In another embodiment, the MU EDCA timer starts after an immediate acknowledgment in response to a TB PPDU transmitted by STA 1406.

In an embodiment, the MU EDCA timer may be used by STA 1406 as a single MU EDCA timer across the PCH (e.g., BSS PCH) and the NPCA PCH. When STA 1406 switches to the NPCA PCH, STA 1406 uses the same MU EDCA parameters as being used on the BSS primary channel. In another embodiment, when STA 1406 switches to the NPCA PCH, STA 1406 uses the same MU EDCA parameters as being used on the BSS primary channel, except that a value of an arbitration interframe space number (AIFSN) for an access category (AC) is set to 0 for all ACs. In an embodiment, setting AIFSN to 0 suspends EDCA backoff for any AC until the MU EDCA timer reaches 0 or is reset to 0. As such, based on the AIFSN being equal to zero, the initiating of a TXOP by STA 1406 occurs after the MU EDCA timer reaches a value of zero.

In an embodiment, the duration may be based on a basic network allocation network (NAV) duration obtained from an inter-BSS PPDU in response to which STA 1406 switches from the PCH to the NPCA PCH. In an embodiment, AP 1404 may inform STA 1406 of the duration to be a percentage/proportion of the basic NAV duration. In another embodiment, the value of the duration may be a value fixed/determined by AP 1404. In an embodiment, AP 1404 may configure the duration for STA 1406 based on a type of traffic that STA 1406 has buffered for AP 1404. In an embodiment (not shown in FIG. 14), there may be other STAs associated with AP 1404 (in addition to STA 1406 being associated with AP 1404), and AP 1404 may configure a respective duration for each STA (e.g., based on the respective traffic buffered at the STA). As such, each STA may have user specific MU EDCA parameters. In another embodiment, AP 1404 may configure/determine the duration based on traffic congestion. In an example, if the traffic is expected to be congested on the NPCA PCH, AP 1404 may set the duration to a higher value. For example, in an embodiment, AP 1404 may set the duration to the value of the basic NAV duration obtained from the inter-BSS PPDU. In another embodiment, AP 1404 may set the duration to a value of a maximum TXOP duration. As such, only triggered uplink transmission may be allowed on the NPCA PCH, while operating on the NPCA PCH. In another embodiment, the duration may be set to a value of zero. As such, STA 1406 may be allowed to initiate a TXOP on the NPCA PCH any time after switching from the PCH to the NPCA PCH.

In another embodiment, AP 1404 may not transmit frame 1408 to STA 1406 on the PCH. In an embodiment, the duration may be predetermined/present, where AP 1404 does not have to inform STA 1406 of the duration with frame 1408. In an embodiment, AP 1404 may have informed STA 1406 of the duration in an earlier frame exchange.

In example 1400, on receiving frame 1408, STA 1406 may determine the duration indicating the time period during which STA 1406, while operating on the NPCA PCH, is not allowed/configured to initiate a TXOP on the NPCA PCH. In an embodiment, receiving a nonzero value of a MU EDCA timer in frame 1408 and that AIFSN[AC] is set to 0 while on the NPCA PCH, STA 1406 may determine not to initiate a TXOP on the NPCA PCH unless the MU EDCA timer value reaches zero while on the NPCA PCH. In another embodiment, STA 1406 may configure the duration, where the duration may be predetermined/preset, without receiving frame 1408. As such, AP 1404 may have informed STA 1406 of the duration in an earlier frame exchange.

Example 1400 may continue with STA 1402 transmitting a frame 1410 on the PCH. By transmitting frame 1410, STA 1402 may obtain a TXOP on the PCH. Frame 1410 may be comprised in a PPDU comprising a TXOP duration field. The TXOP duration field may indicate a TXOP duration 1412. TXOP duration 1412 may indicate a duration that starts by the end of frame 1410 (e.g., starting at a time T1) and that ends at a time T2 as shown in FIG. 14. After transmitting frame 1410, STA 1402 may communicate with its associated STAs via the PCH within TXOP duration 1412. In an embodiment, STA 1402 may perform uplink and/or downlink communications as illustrated with a frame exchange 1414. In example 1400, frame exchange 1414 may extend to the end of TXOP duration 1412.

In an embodiment, on receiving frame 1410, AP 1404 may determine that frame 1410 is comprised in an inter-BSS PPDU (OBSS PPDU). As discussed above in relation to FIG. 11 and in accordance with NPCA operation, based on determining that frame 1410 is comprised in an inter-BSS PPDU, AP 1404 may set a NAV 1416 for the PCH based on TXOP duration 1412 and may switch from the PCH to the NPCA PCH for TXOP duration 1412 (OBSS NAV duration for AP 1404). In example 1400, AP 1404 may switch to the NPCA PCH at a time T1. After switching to the NPCA PCH, AP 1404 may be involved in uplink and/or downlink communications with its associated STAs. In example 1400, after switching to the NPCA PCH, uplink communications between AP 1404 and its associated STAs (e.g., STA 1406) may be performed via only triggered-based (TB) physical layer (PHY) protocol data unit (PPDU) transmission for the duration indicated in frame 1408 or in an earlier frame exchange. In an embodiment, the duration indicates a time period (denoted by T in FIG. 14) that starts at the time switching has occurred (e.g., at time T1). In another embodiment (not shown in FIG. 14), the time period indicated by the duration may start a short interframe spacing (SIFS) or a point coordination function (PCF) interframe spacing (PIFS) after the time switching has occurred. Accordingly, after switching to the NPCA PCH, a STA associated with AP 1404 (e.g., STA 1406) may only transmit a frame to AP 1404 in response to a trigger frame from AP 1404 during the time period indicated by the duration (e.g., T). In other words, after switching to the NPCA PCH, a STA associated with AP 1404 (e.g., STA 1406) may not initiate a transmission if not triggered by AP 1404 during the time period indicated by the duration. Allowing only triggered uplink communications on the NPCA PCH during the time period indicated by the duration facilitate AP 1404 obtaining control of the NPCA PCH, especially when a large number of STAs contend for the NPCA PCH and the STAs have asynchronous switching times due to different implementations.

In an embodiment, on receiving frame 1410, STA 1406 may determine that frame 1410 is comprised in an inter-BSS PPDU (OBSS PPDU). Based on determining that frame 1410 is comprised in an inter-BSS PPDU, STA 1406 may set a NAV 1418 for the PCH based on TXOP duration 1412 and may switch from the PCH to the NPCA PCH for TXOP duration 1412 (OBSS NAV duration for STA 1406). In example 1400, STA 1406 may switch to the NPCA PCH at a time T1. Based on switching to the NPCA PCH, STA 1406 may set AIFSN to 0, preventing/refraining STA 1406 initiating a TXOP on the NPCA PCH while the value of the MU EDCA timer is nonzero. In an embodiment, the MU EDCA timer reaches zero by the end of duration T as illustrated in FIG. 14, where STA 1406 may initiate a TXOP on the NPCA PCH after the duration T. After switching to the NPCA PCH, based on being associated with AP 1404 and being configured/informed to perform only TB PPDU transmission on the NPCA PCH after switching to the NPCA PCH during the duration (e.g., starting at T1 for the duration T as illustrated in FIG. 14), STA 1406 may be involved in downlink communications and/or trigger based uplink communications with AP 1404 during the duration. As such, STA 1406 does not initiate a TXOP on the NPCA PCH after switching from the PCH for the duration T; however, STA 1406 may initiate a TXOP on the NPCA PCH after the duration T, if the NPCA PCH is idle. In an embodiment, STA 1406 may initiate a TXOP on the NPCA PCH after the MU EDCA timer reaches a value of zero (while AIFSN is equal to zero).

In an embodiment, after switching to the NPCA PCH, AP 1404 may start a “MediumSyncDelay” timer for the medium synchronization duration of the NPCA PCH, and if the NPCA PCH is idle (at/after expiration of the MediumSyncDelay timer), AP 1404 may access the NPCA PCH to transmit a frame on the NPCA PCH. In example 1400, after expiration of the MediumSyncDelay timer, AP 1404 may detect that the NPCA PCH is not idle during a busy duration 1420). As such, AP 1404 may not access the NPCA PCH to transmit a frame during busy duration 1420. In an embodiment, busy duration 1420 may be due to another OBSS transmission on the NPCA PCH, where AP 1404 may detect the OBSS transmission. In another embodiment, busy duration 1420 may be due to AP 1404 contending for the NPCA PCH but not obtaining control of the channel. In another embodiment, busy duration 1420 may be due to a busy channel condition for AP 1404. As such, AP 1404 may not perform downlink communications and/or trigger its associated STAs (e.g., STA 1406) for uplink communications during busy duration 1420.

In an embodiment, after switching from the PCH to the NPCA PCH, STA 1406 may set a timer based on the duration. In an embodiment, the timer starts at the switching time T1. In another embodiment, the timer starts a SIFS or a PIFS after the switching time T1. In another embodiment, setting a timer based on the duration corresponds to setting the AIFSN to zero based on switching to the NPCA PCH. In an embodiment, the MU EDCA timer while AIFSN is set to zero corresponds to a timer starting at the switching time T1 that suspends initiating a TXOP until the timer expires. In an embodiment, when the timer has a nonzero value, STA 1406 is not allowed/configured to initiate a TXOP on the NPCA PCH. In an embodiment, AP 1404 may not trigger STA 1406 due to busy duration 1420 during the duration. In an embodiment, after the timer is expired (value of the timer is zero), STA 1406 may initiate a TXOP on the NPCA PCH to transmit a non-trigger based PPDU to AP 1404. In order to do so, STA 1406 should observe the NPCA PCH to be idle. In an embodiment, STA 1406 may observe NPCA PCH to be idle due to not detecting busy duration 1420 on the NPCA PCH. This may be due to STA 1406 being outside the communication range of the OBSS transmission on the NPCA PCH. In an embodiment, STA 1406 may have low latency traffic to AP 1404. In an embodiment, having buffered traffic to AP 1404 and since not being triggered during the duration, STA 1406 may transmit to AP 1404 a frame 1422 on condition that a value of the timer is zero. In an embodiment, frame 1422 may be a non-TB PPDU.

In an embodiment, AP 1404 may receive frame 1422 successfully. In an embodiment, AP 1404 may transmit a frame 1424 in response to frame 1422. In an embodiment, frame 1424 may be a BA frame. In another embodiment, AP 1404 may not receive frame 1422 successfully. As such, AP 1404 may not transmit a BA frame. As illustrated in example 1400, by defining a duration, which indicates a time period during which STA 1406, while operating on an NPCA PCH, is not allowed/configured to initiate a TXOP on the NPCA PCH, STA 1406 may have an opportunity to initiate a TXOP after/outside the duration and may transmit its buffered traffic, if not triggered by AP 1404 within the duration. In case AP 1404 may be prevented from triggering STA 1406 during busy duration 1420, the proposed solution enables quicker transmission of low latency traffic.

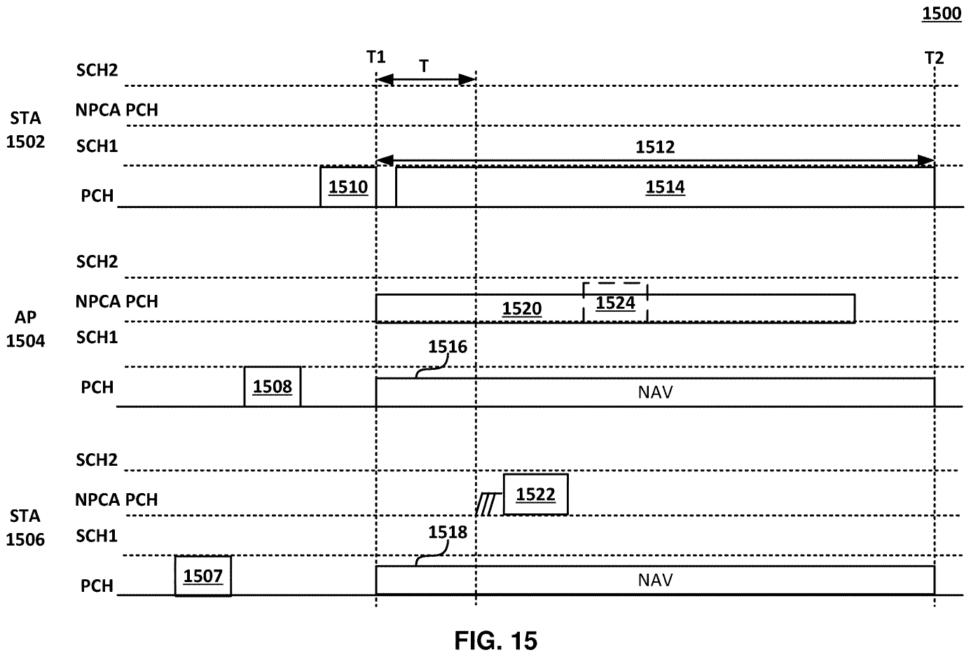

FIG. 15 shows another example 1500 that illustrates an example NPCA operation according to an embodiment. As shown in FIG. 15, example 1500 includes STA 1502, AP 1504, and STA 1506. AP 1504 and STA 1506 may belong to the same BSS. STA 1502 may belong to a different BSS than AP 1504 and STA 1506. In an example, STA 1502 may be an AP STA or a non-AP STA. In an embodiment, AP 1504 may be an AP STA, and STA 1506 may be a non-AP STA. In an embodiment, where AP 1504 is an AP STA and STA 1506 is a non-AP STA, STA 1506 may be associated with AP 1504. In an embodiment, AP 1504 and STA 1506 may support NPCA operation and may operate over a plurality of channels, including a primary channel (PCH), an NPCA primary channel (NPCA PCH), a first secondary channel (SCH1), and a second secondary channel (SCH2).

As shown in FIG. 15, example 1500 may begin with STA 1506 transmitting a frame 1507 to AP 1504 on the PCH. In an embodiment, frame 1507 may comprise a management frame, an action frame, a control frame, a quality of service (QoS) null frame, or a QoS data frame. In an embodiment, frame 1507 may request a duration. In an embodiment, the duration indicates a time period during which STA 1506, while operating on the NPCA PCH, is not allowed/configured to initiate a TXOP on the NPCA PCH. As such, STA 1506 may request the duration in order to be able to initiate a TXOP on the NPCA PCH after/outside the duration. In an embodiment, the duration indicates a time period during which STA 1506 is not allowed/configured to transmit a non-trigger based (non-TB) physical layer protocol data unit (PPDU) to the AP via the NPCA PCH. In another embodiment, the duration indicates a time period during which STA 1506 does not transmit a non-TB PPDU to the AP via the NPCA PCH. In another embodiment, the duration indicates a time period during which STA 1506 is not allowed to transmit a non-TB PPDU to the AP via the NPCA PCH but is allowed to transmit a TB PPDU to the AP via the NPCA PCH.

In an embodiment, on receiving frame 1507, AP 1504 may transmit a frame 1508 to STA 1506 in response. In an embodiment, frame 1508 may comprise a management frame, an action frame, a control frame, a quality of service (QoS) null frame, or a QoS data frame. In an embodiment, frame 1508 may indicate acceptance of the requested duration. As such, in an embodiment, frame 1508 may indicate a value of the duration requested. In another embodiment, frame 1508 may indicate rejection of the requested duration. In another embodiment, frame 1508 may indicate a second duration different than the requested duration. As such, AP 1504 may consider various conditions/options to determine the requested duration and to inform STA 1506 of the duration.

In an embodiment, the duration may be based on a portion of a basic network allocation network (NAV) duration obtained from an inter-BSS PPDU in response to which STA 1506 switches from the PCH to the NPCA PCH. In an embodiment, AP 1504 may inform STA 1506 of the duration to be a percentage/proportion of the basic NAV duration. In another embodiment, the value of the duration may be a value fixed/determined by AP 1504. In an embodiment, AP 1504 may configure the duration for STA 1506 based on a type of traffic that STA 1506 has buffered for AP 1504. In an embodiment (not shown in FIG. 15), there may be other STAs associated with AP 1504 (in addition to STA 1506 being associated with AP 1504), and AP may configure a respective duration for each STA (e.g., based on the respective traffic buffered at the STA). In another embodiment, AP 1504 may configure/determine the duration based on traffic congestion. In an example, if the traffic is expected to be congested on the NPCA PCH, AP 1504 may set the duration to a higher value. For example, in an embodiment, AP 1504 may set the duration to a value of the basic NAV duration obtained from the inter-BSS PPDU. In another embodiment, AP 1504 may set the duration to a value of a maximum TXOP duration. As such, only triggered uplink transmission may be allowed on the NPCA PCH, while operating on the NPCA PCH. In another embodiment, the duration may be set to a value of zero. As such, STA 1506 may be allowed to initiate a TXOP on the NPCA PCH any time after switching from the PCH to the NPCA PCH.

In example 1500, on receiving frame 1508, STA 1506 may determine the duration indicating the time period during which STA 1506, while operating on the NPCA PCH, is not allowed/configured to initiate a TXOP on the NPCA PCH.

Example 1500 may continue with STA 1502 transmitting a frame 1510 on the PCH. By transmitting frame 1510, STA 1502 may obtain a TXOP on the PCH. Frame 1510 may be comprised in a PPDU comprising a TXOP duration field. The TXOP duration field may indicate a TXOP duration 1512. TXOP duration 1512 may indicate a duration that starts by the end of frame 1510 (e.g., starting at a time T1) and that ends at a time T2 as shown in FIG. 15. After transmitting frame 1510, STA 1502 may communicate with its associated STAs via the PCH within TXOP duration 1512. In an embodiment, STA 1502 may perform uplink and/or downlink communications as illustrated with a frame exchange 1514. In example 1500, frame exchange 1514 may extend to the end of TXOP duration 1512.

In an embodiment, on receiving frame 1510, AP 1504 may determine that frame 1510 is comprised in an inter-BSS PPDU (OBSS PPDU). As discussed above in relation to FIG. 11 and in accordance with NPCA operation, based on determining that frame 1510 is comprised in an inter-BSS PPDU, AP 1504 may set a NAV 1516 for the PCH based on TXOP duration 1512 and may switch from the PCH to the NPCA PCH for TXOP duration 1512 (OBSS NAV duration for AP 1504). In example 1500, AP 1504 may switch to the NPCA PCH at a time T1. After switching to the NPCA PCH, AP 1504 may be involved in uplink and/or downlink communications with its associated STAs. In example 1500, after switching to the NPCA PCH, uplink communications between AP 1504 and its associated STAs (e.g., STA 1406) may be performed via only triggered-based (TB) physical layer (PHY) protocol data unit (PPDU) transmission for the duration indicated in frame 1508 or in an earlier frame exchange. In an embodiment, the time period indicated by the duration (denoted by T in FIG. 15) may start at the time switching has occurred (e.g., at time T1). In another embodiment (not shown in FIG. 15), the time period indicated by the duration may start a short interframe spacing (SIFS) or a point coordination function (PCF) interframe spacing (PIFS) after the time switching has occurred. Accordingly, after switching to the NPCA PCH, a STA associated with AP 1504 (e.g., STA 1506) may only transmit a frame to AP 1504 in response to a trigger frame from AP 1504 during the time period indicated by the duration (e.g., T). In other words, after switching to the NPCA PCH, a STA associated with AP 1504 (e.g., STA 1506) may not initiate a transmission if not triggered by AP 1504 during the time period indicated by the duration. Allowing only triggered uplink communications on the NPCA PCH during the time period indicated by the duration facilitate AP 1504 obtaining control of the NPCA PCH, especially when a large number of STAs contend for the NPCA PCH and the STAs have asynchronous switching times due to different implementations.

In an embodiment, on receiving frame 1510, STA 1506 may determine that frame 1510 is comprised in an inter-BSS PPDU (OBSS PPDU). Based on determining that frame 1510 is comprised in an inter-BSS PPDU, STA 1506 may set a NAV 1518 for the PCH based on TXOP duration 1512 and may switch from the PCH to the NPCA PCH for TXOP duration 1512 (OBSS NAV duration for STA 1506). In example 1500, STA 1506 may switch to the NPCA PCH at a time T1. After switching to the NPCA PCH, based on being associated with AP 1504 and being configured/informed to perform only TB PPDU transmission on the NPCA PCH after switching to the NPCA PCH during the duration (e.g., starting at T1 for the duration T as illustrated in FIG. 15), STA 1506 may be involved in downlink communications and/or trigger based uplink communications with AP 1504 during the duration. As such, STA 1506 does not initiate a TXOP on the NPCA PCH after switching from the PCH for the duration T, however; however, STA 1506 may initiate a TXOP on the NPCA PCH after the duration T, if the NPCA PCH is idle.

In an embodiment, after switching to the NPCA PCH, AP 1504 may start a “MediumSyncDelay” timer for the medium synchronization duration of the NPCA PCH, and if the NPCA PCH is idle (at/after expiration of the MediumSyncDelay timer), AP 1504 may access the NPCA PCH to transmit a frame on the NPCA PCH. In example 1500, after expiration of the MediumSyncDelay timer, AP 1504 may detect that the NPCA PCH is not idle during a busy duration 1520. As such, AP 1504 may not access the NPCA PCH to transmit a frame during busy duration 1520. In an embodiment, busy duration 1520 may be due to another OBSS transmission on the NPCA PCH, where AP 1504 may detect the OBSS transmission. In another embodiment, busy duration 1520 may be due to AP 1504 contending for the NPCA PCH but not obtaining control of the channel. In another embodiment, busy duration 1520 may be due to a busy channel condition for AP 1504. As such, AP 1504 may not perform downlink communications and/or trigger its associated STAs (e.g., STA 1506) for uplink communications during busy duration 1520.

In an embodiment, after switching from the PCH to the NPCA PCH, STA 1506 may set a timer based on the duration. In an embodiment, the timer starts at the switching time T1. In another embodiment, the timer starts a SIFS or a PIFS after the switching time T1. In an embodiment, when the timer has a nonzero value, STA 1506 is not allowed/configured to initiate a TXOP on the NPCA PCH. In an embodiment, AP 1504 may not trigger STA 1506 due to busy duration 1520 during the duration. In an embodiment, after the timer is expired (value of the timer is zero), STA 1506 may initiate a TXOP on the NPCA PCH to transmit a non-trigger based PPDU to AP 1504. In order to do so, STA 1506 should observe the NPCA PCH to be idle. In an embodiment, STA 1506 may observe NPCA PCH to be idle due to not detecting busy duration 1520 on the NPCA PCH. This may be due to STA 1506 being outside the communication range of the OBSS transmission on the NPCA PCH. In an embodiment, STA 1506 may have low latency traffic to AP 1504. In an embodiment, having buffered traffic to AP 1504 and since not being triggered during the duration, STA 1506 may transmit to AP 1504 a frame 1522 on condition that a value of the timer is zero. In an embodiment, frame 1522 may be a non-TB PPDU.

In an embodiment, AP 1504 may receive frame 1522 successfully. In an embodiment, AP 1504 may transmit a frame 1524 in response to frame 1522. In an embodiment, frame 1524 may be a BA frame. In another embodiment, AP 1504 may not receive frame 1522 successfully. As such, AP 1504 may not transmit a BA frame. As illustrated in example 1500, by defining a duration, which indicates a time period during which STA 1506, while operating on an NPCA PCH, is not allowed/configured to initiate a TXOP on the NPCA PCH, STA 1506 may have an opportunity to initiate a TXOP after/outside the duration and may transmit its buffered traffic, if not triggered by AP 1504 within the duration. In case AP 1504 may be prevented from triggering STA 1506 during busy duration 1520, the proposed solution enables quicker transmission of low latency traffic.

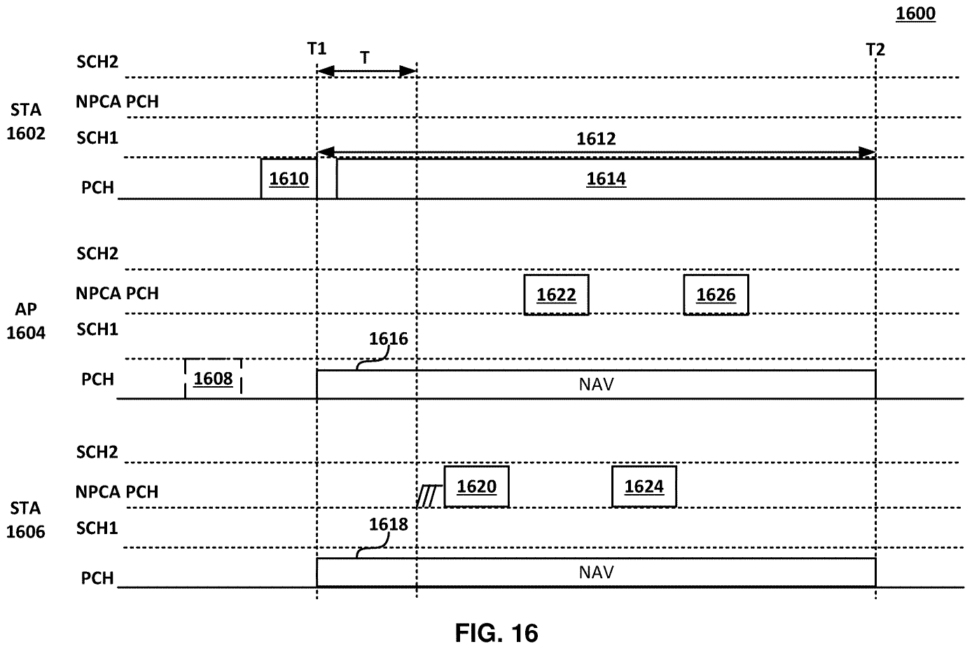

FIG. 16 shows another example 1600 that illustrates an example NPCA operation according to an embodiment. As shown in FIG. 16, example 1600 includes STA 1602, AP 1604, and STA 1606. AP 1604 and STA 1606 may belong to the same BSS. STA 1602 may belong to a different BSS than AP 1604 and STA 1606. In an example, STA 1602 may be an AP STA or a non-AP STA. In an embodiment, AP 1604 may be an AP STA, and STA 1606 may be a non-AP STA. In an embodiment, where AP 1604 is an AP STA and STA 1606 is a non-AP STA, STA 1606 may be associated with AP 1604. In an embodiment, AP 1604 and STA 1606 may support NPCA operation and may operate over a plurality of channels, including a primary channel (PCH), an NPCA primary channel (NPCA PCH), a first secondary channel (SCH1), and a second secondary channel (SCH2).

As shown in FIG. 16, example 1600 may begin with AP 1604 transmitting a frame 1608 to STA 1606 on the PCH. In an embodiment, frame 1608 may comprise a management frame, an action frame, a control frame, a quality of service (QoS) null frame, or a QoS data frame. In an embodiment, where frame 1608 comprises the management frame, the management frame may comprise a beacon frame. In an embodiment, frame 1608 may indicate a duration. In an embodiment, the duration indicates a time period during which STA 1606, while operating on the NPCA PCH, is not allowed/configured to initiate a TXOP on the NPCA PCH. In an embodiment, the duration indicates a time period during which STA 1606 is not allowed/configured to transmit a non-trigger based (non-TB) physical layer protocol data unit (PPDU) to the AP via the NPCA PCH. In another embodiment, the duration indicates a time period during which STA 1606 does not transmit a non-TB PPDU to the AP via the NPCA PCH. In another embodiment, the duration indicates a time period during which STA 1606 is not allowed to transmit a non-TB PPDU to the AP via the NPCA PCH but is allowed to transmit a TB PPDU to the AP via the NPCA PCH.

In an embodiment, the duration may be based on a basic network allocation network (NAV) duration obtained from an inter-BSS PPDU in response to which STA 1606 switches from the PCH to the NPCA PCH. In an embodiment, AP 1604 may inform STA 1606 of the duration to be a percentage/proportion of the basic NAV duration. In another embodiment, the value of the duration may be a value fixed/determined by AP 1604. In an embodiment, AP 1604 may configure the duration for STA 1606 based on a type of traffic that STA 1606 has buffered for AP 1604. In an embodiment (not shown in FIG. 16), there may be other STAs associated with AP 1604 (in addition to STA 1606 being associated with AP 1604), and AP 1604 may configure a respective duration for each STA (e.g., based on the respective traffic buffered at the STA). In another embodiment, AP 1604 may configure/determine the duration based on traffic congestion. In an example, if the traffic is expected to be congested on the NPCA PCH, AP 1604 may set the duration to a higher value. For example, in an embodiment, AP 1604 may set the duration to the value of the basic NAV duration obtained from the inter-BSS PPDU. In another embodiment, AP 1604 may set the duration to a value of a maximum TXOP duration. As such, only triggered uplink transmission may be allowed on the NPCA PCH, while operating on the NPCA PCH. In another embodiment, the duration may be set to a value of zero. As such, STA 1606 may be allowed to initiate a TXOP on the NPCA PCH any time after switching from the PCH to the NPCA PCH.

In another embodiment, AP 1604 may not transmit frame 1608 to STA 1606 on the PCH. In an embodiment, the duration may be predetermined/present, where AP 1604 does not have to inform STA 1606 of the duration with frame 1608. In an embodiment, AP 1604 may have informed STA 1606 of the duration in an earlier frame exchange.

In example 1600, on receiving frame 1608, STA 1606 may determine the duration indicating the time period during which STA 1606, while operating on the NPCA PCH, is not allowed/configured to initiate a TXOP on the NPCA PCH. In another embodiment, STA 1606 may configure the duration, where the duration may be predetermined/preset, without receiving frame 1608. As such, AP 1604 may have informed STA 1606 of the duration in an earlier frame exchange.

Example 1600 may continue with STA 1602 transmitting a frame 1610 on the PCH. By transmitting frame 1610, STA 1602 may obtain a TXOP on the PCH. Frame 1610 may be comprised in a PPDU comprising a TXOP duration field. The TXOP duration field may indicate a TXOP duration 1612. TXOP duration 1612 may indicate a duration that starts by the end of frame 1610 (e.g., starting at a time T1) and that ends at a time T2 as shown in FIG. 16. After transmitting frame 1610, STA 1602 may communicate with its associated STAs via the PCH within TXOP duration 1612. In an embodiment, STA 1602 may perform uplink and/or downlink communications as illustrated with a frame exchange 1614. In example 1600, frame exchange 1614 may extend to the end of TXOP duration 1612.

In an embodiment, on receiving frame 1610, AP 1604 may determine that frame 1610 is comprised in an inter-BSS PPDU (OBSS PPDU). As discussed above in relation to FIG. 11 and in accordance with NPCA operation, based on determining that frame 1610 is comprised in an inter-BSS PPDU, AP 1604 may set a NAV 1616 for the PCH based on TXOP duration 1612 and may switch from the PCH to the NPCA PCH for TXOP duration 1612 (OBSS NAV duration for AP 1604). In example 1600, AP 1604 may switch to the NPCA PCH at a time T1. After switching to the NPCA PCH, AP 1604 may be involved in uplink and/or downlink communications with its associated STAs. In example 1600, after switching to the NPCA PCH, uplink communications between AP 1604 and its associated STAs (e.g., STA 1606) may be performed via only triggered-based (TB) physical layer (PHY) protocol data unit (PPDU) transmission for the duration indicated in frame 1608 or in an earlier frame exchange. In an embodiment, the time period indicated by the duration (denoted by T in FIG. 16) may start at the time switching has occurred (e.g., at time T1). In another embodiment (not shown in FIG. 16), the time period indicated by the duration may start a short interframe spacing (SIFS) or a point coordination function (PCF) interframe spacing (PIFS) after the time switching has occurred. Accordingly, after switching to the NPCA PCH, a STA associated with AP 1604 (e.g., STA 1606) may only transmit a frame to AP 1604 in response to a trigger frame from AP 1604 during the time period indicated by the duration (e.g., T). In other words, after switching to the NPCA PCH, a STA associated with AP 1604 (e.g., STA 1606) may not initiate a transmission if not triggered by AP 1604 during the time period indicated by the duration. Allowing only triggered uplink communications on the NPCA PCH during the time period indicated by the duration facilitate AP 1604 obtaining control of the NPCA PCH, especially when a large number of STAs contend for the NPCA PCH and the STAs have asynchronous switching times due to different implementations.

In an embodiment, on receiving frame 1610, STA 1606 may determine that frame 1610 is comprised in an inter-BSS PPDU (OBSS PPDU). Based on determining that frame 1610 is comprised in an inter-BSS PPDU, STA 1606 may set a NAV 1618 for the PCH based on TXOP duration 1612 and may switch from the PCH to the NPCA PCH for TXOP duration 1612 (OBSS NAV duration for STA 1606). In example 1600, STA 1606 may switch to the NPCA PCH at a time T1. After switching to the NPCA PCH, based on being associated with AP 1604 and being configured/informed to perform only TB PPDU transmission on the NPCA PCH after switching to the NPCA PCH during the duration (e.g., starting at T1 for the duration T as illustrated in FIG. 16), STA 1606 may be involved in downlink communications and/or trigger based uplink communications with AP 1604 during the duration. As such, STA 1606 does not initiate a TXOP on the NPCA PCH after switching from the PCH for the duration T; however, STA 1606 may initiate a TXOP on the NPCA PCH after the duration T, if the NPCA PCH is idle.

In an embodiment, after switching to the NPCA PCH, AP 1604 may start a “MediumSyncDelay” timer for the medium synchronization duration of the NPCA PCH, and if the NPCA PCH is idle (at/after expiration of the MediumSyncDelay timer), AP 1604 may access the NPCA PCH to transmit a frame on the NPCA PCH. In an embodiment, AP 1604 may not have obtained control of the NPCA PCH during the duration T. In another embodiment (not shown in FIG. 16), AP 1604 may have performed downlink communications with one or more of its associated STAs during the duration T. In another embodiment (not shown in FIG. 16), AP 1604 may have performed triggered uplink communications with one or more of its associated STAs during the duration T. In an embodiment, AP 1604 may not have triggered STA 1606 to perform uplink communications during the duration T.

In an embodiment, after switching from the PCH to the NPCA PCH, STA 1606 may set a timer based on the duration. In an embodiment, the timer starts at the switching time T1. In another embodiment, the timer starts a SIFS or a PIFS after the switching time T1. In an embodiment, when the timer has a nonzero value, STA 1606 is not allowed/configured to initiate a TXOP on the NPCA PCH. In an embodiment, after the timer is expired (value of the timer is zero), STA 1606 may initiate a TXOP on the NPCA PCH to transmit a non-triggered based PPDU to AP 1604. In order to do so, STA 1606 should observe the NPCA PCH to be idle. In an embodiment, STA 1606 may observe NPCA PCH to be idle. In an embodiment, STA 1606 may have low latency traffic to AP 1604. In an embodiment, having buffered traffic to AP 1604 and since not being triggered during the duration T, STA 1606 may transmit to AP 1604 a frame 1624 on condition that a value of the timer is zero. In an embodiment, frame 1624 may be a non-TB PPDU.

In an embodiment, before transmitting frame 1624 to AP 1604, STA 1606 may transmit a frame 1620 to AP 1604. In an embodiment, frame 1620 may comprise an initial control frame (ICF). In another embodiment, frame 1620 may comprise a request-to-send (RTS) frame. In response to frame 1620, AP 1604 may perform CCA and transmit a frame 1622 to STA 1606, if CCA indicates NPCA PCH is idle. In an embodiment, frame 1622 may comprise an initial control response frame (ICR). In another embodiment, frame 1622 may comprise a clear-to-send (CTS) frame. As such, the transmitting of frame 1624 follows the reception of frame 1622. In an embodiment, AP 1604 may receive frame 1624 successfully. In an embodiment, AP 1604 may transmit a frame 1626 in response to frame 1624. In an embodiment, frame 1626 may be a BA frame. As illustrated in example 1600, by defining a duration, which indicates a time period during which STA 1606, while operating on an NPCA PCH, is not allowed/configured to initiate a TXOP on the NPCA PCH, STA 1606 may have an opportunity to initiate a TXOP after/outside the duration and may transmit its buffered traffic, if not triggered by AP 1604 within the duration.

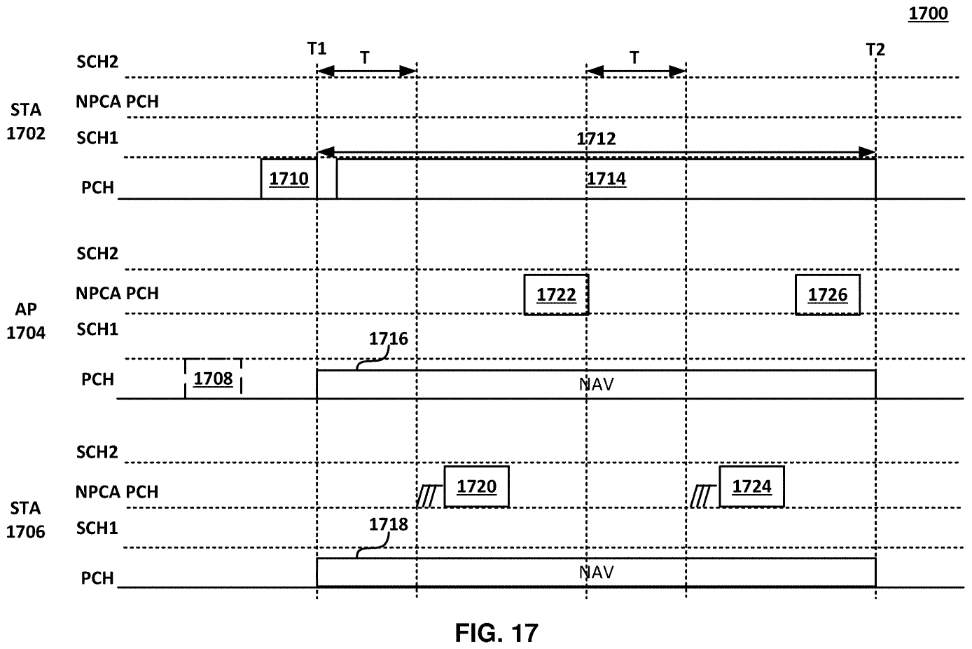

FIG. 17 shows another example 1700 that illustrates an example NPCA operation according to an embodiment. As shown in FIG. 17, example 1700 includes STA 1702, AP 1704, and STA 1706. AP 1704 and STA 1706 may belong to the same BSS. STA 1702 may belong to a different BSS than AP 1704 and STA 1706. In an example, STA 1702 may be an AP STA or a non-AP STA. In an embodiment, AP 1704 may be an AP STA, and STA 1706 may be a non-AP STA. In an embodiment, where AP 1704 is an AP STA and STA 1706 is a non-AP STA, STA 1706 may be associated with AP 1704. In an embodiment, AP 1704 and STA 1706 may support NPCA operation and may operate over a plurality of channels, including a primary channel (PCH), an NPCA primary channel (NPCA PCH), a first secondary channel (SCH1), and a second secondary channel (SCH2).

As shown in FIG. 17, example 1700 may begin with AP 1704 transmitting a frame 1708 to STA 1706 on the PCH. In an embodiment, frame 1708 may comprise a management frame, an action frame, a control frame, a quality of service (QoS) null frame, or a QoS data frame. In an embodiment, where frame 1708 comprises the management frame, the management frame may comprise a beacon frame. In an embodiment, frame 1708 may indicate a duration. In an embodiment, the duration indicates a time period during which STA 1706, while operating on the NPCA PCH, is not allowed/configured to initiate a TXOP on the NPCA PCH. In an embodiment, the duration indicates a time period during which STA 1706 is not allowed/configured to transmit a non-trigger based (non-TB) physical layer protocol data unit (PPDU) to the AP via the NPCA PCH. In another embodiment, the duration indicates a time period during which STA 1706 does not transmit a non-TB PPDU to the AP via the NPCA PCH. In another embodiment, the duration indicates a time period during which STA 1706 is not allowed to transmit a non-TB PPDU to the AP via the NPCA PCH but is allowed to transmit a TB PPDU to the AP via the NPCA PCH.

In an embodiment, the duration may be based on a basic network allocation network (NAV) duration obtained from an inter-BSS PPDU in response to which STA 1706 switches from the PCH to the NPCA PCH. In an embodiment, AP 1704 may inform STA 1706 of the duration to be a percentage/proportion of the basic NAV duration. In another embodiment, the value of the duration may be a value fixed/determined by AP 1704. In an embodiment, AP 1704 may configure the duration for STA 1706 based on a type of traffic that STA 1706 has buffered for AP 1704. In an embodiment (not shown in FIG. 17), there may be other STAs associated with AP 1704 (in addition to STA 1706 being associated with AP 1704), and AP 1704 may configure a respective duration for each STA (e.g., based on the respective traffic buffered at the STA). In another embodiment, AP 1704 may configure/determine the duration based on traffic congestion. In an example, if the traffic is expected to be congested on the NPCA PCH, AP 1704 may set the duration to a higher value. For example, in an embodiment, AP 1704 may set the duration to the value of the basic NAV duration obtained from the inter-BSS PPDU. In another embodiment, AP 1704 may set the duration to a value of a maximum TXOP duration. As such, only triggered uplink transmission may be allowed on the NPCA PCH, while operating on the NPCA PCH. In another embodiment, the duration may be set to a value of zero. As such, STA 1706 may be allowed to initiate a TXOP on the NPCA PCH any time after switching.

In another embodiment, AP 1704 may not transmit frame 1708 to STA 1706 on the PCH. In an embodiment, the duration may be predetermined/present, where AP 1704 does not have to inform STA 1706 of the duration with frame 1708. In an embodiment, AP 1704 may have informed STA 1706 of the duration in an earlier frame exchange.

In example 1700, on receiving frame 1708, STA 1706 may determine the duration indicating the time period during which STA 1706, while operating on the NPCA PCH, is not allowed/configured to initiate a TXOP on the NPCA PCH. In another embodiment, STA 1706 may configure the duration, where the duration may be predetermined/preset, without receiving frame 1708. As such, AP 1704 may have informed STA 1706 of the duration in an earlier frame exchange.

Example 1700 may continue with STA 1702 transmitting a frame 1710 on the PCH. By transmitting frame 1710, STA 1702 may obtain a TXOP on the PCH. Frame 1710 may be comprised in a PPDU comprising a TXOP duration field. The TXOP duration field may indicate a TXOP duration 1712. TXOP duration 1712 may indicate a duration that starts by the end of frame 1710 (e.g., starting at a time T1) and that ends at a time T2 as shown in FIG. 17. After transmitting frame 1710, STA 1702 may communicate with its associated STAs via the PCH within TXOP duration 1712. In an embodiment, STA 1702 may perform uplink and/or downlink communications as illustrated with a frame exchange 1714. In example 1700, frame exchange 1714 may extend to the end of TXOP duration 1712.

In an embodiment, on receiving frame 1710, AP 1704 may determine that frame 1710 is comprised in an inter-BSS PPDU (OBSS PPDU). As discussed above in relation to FIG. 11 and in accordance with NPCA operation, based on determining that frame 1710 is comprised in an inter-BSS PPDU, AP 1704 may set a NAV 1716 for the PCH based on TXOP duration 1712 and may switch from the PCH to the NPCA PCH for TXOP duration 1712 (OBSS NAV duration for AP 1704). In example 1700, AP 1704 may switch to the NPCA PCH at a time T1. After switching to the NPCA PCH, AP 1704 may be involved in uplink and/or downlink communications with its associated STAs. In example 1700, after switching to the NPCA PCH, uplink communications between AP 1704 and its associated STAs (e.g., STA 1706) may be performed via only triggered-based (TB) physical layer (PHY) protocol data unit (PPDU) transmission for the duration indicated in frame 1708 or in an earlier frame exchange. In an embodiment, the time period indicated by the duration (denoted by T in FIG. 17) may start at the time switching has occurred (e.g., at time T1). In another embodiment (not shown in FIG. 17), the time period indicated by the duration may start a short interframe spacing (SIFS) or a point coordination function (PCF) interframe spacing (PIFS) after the time switching has occurred. Accordingly, after switching to the NPCA PCH, a STA associated with AP 1704 (e.g., STA 1706) may only transmit a frame to AP 1704 in response to a trigger frame from AP 1704 during the time period indicated by the duration (e.g., T). In other words, after switching to the NPCA PCH, a STA associated with AP 1704 (e.g., STA 1706) may not initiate a transmission if not triggered by AP 1704 during the time period indicated by the duration. Allowing only triggered uplink communications on the NPCA PCH during the time period indicated by the duration facilitate AP 1704 obtaining control of the NPCA PCH, especially when a large number of STAs contend for the NPCA PCH and the STAs have asynchronous switching times due to different implementations.

In an embodiment, on receiving frame 1710, STA 1706 may determine that frame 1710 is comprised in an inter-BSS PPDU (OBSS PPDU). Based on determining that frame 1710 is comprised in an inter-BSS PPDU, STA 1706 may set a NAV 1718 for the PCH based on TXOP duration 1712 and may switch from the PCH to the NPCA PCH for TXOP duration 1712 (OBSS NAV duration for STA 1706). In example 1700, STA 1706 may switch to the NPCA PCH at a time T1. After switching to the NPCA PCH, based on being associated with AP 1704 and being configured/informed to perform only TB PPDU transmission on the NPCA PCH after switching to the NPCA PCH during the duration (e.g., starting at T1 for the duration T as illustrated in FIG. 17), STA 1706 may be involved in downlink communications and/or trigger based uplink communications with AP 1704 during the duration. As such, STA 1706 does not initiate a TXOP on the NPCA PCH after switching from the PCH for the duration T; however, STA 1706 may initiate a TXOP on the NPCA PCH after the duration T, if the NPCA PCH is idle. In an embodiment, STA 1706 may be configured to initiate only a first TXOP on the NPCA PCH. In another embodiment, STA 1706 may be configured to initiate a second TXOP on the NPCA PCH after the first TXOP. In an embodiment, initiating the second TXOP may occur a SIFS or a PIFS after an end of the first TXOP. In another embodiment, initiating the second TXOP after the first TXOP may occur a duration T after an end of the first TXOP.

In an embodiment, after switching to the NPCA PCH, AP 1704 may start a “MediumSyncDelay” timer for the medium synchronization duration of the NPCA PCH, and if the NPCA PCH is idle (at/after expiration of the MediumSyncDelay timer), AP 1704 may access the NPCA PCH to transmit a frame on the NPCA PCH. In an embodiment, AP 1704 may not have obtained control of the NPCA PCH during the duration T (starting at time T1). In another embodiment (not shown in FIG. 17), AP 1704 may have performed downlink communications with one or more of its associated STAs during the duration T (starting at time T1). In another embodiment (not shown in FIG. 17), AP 1704 may have performed triggered uplink communications with one or more of its associated STAs during the duration T (starting at time T1). In an embodiment, AP 1704 may not have triggered STA 1706 to perform uplink communications during the duration T (starting at time T1).

In an embodiment, after switching from the PCH to the NPCA PCH, STA 1706 may set a timer based on the duration. In an embodiment, the timer starts at the switching time T1. In another embodiment, the timer starts a SIFS or a PIFS after the switching time T1. In an embodiment, when the timer has a nonzero value, STA 1706 is not allowed/configured to initiate a TXOP on the NPCA PCH. In an embodiment, after the timer is expired (value of the timer is zero), STA 1706 may initiate a TXOP on the NPCA PCH to transmit a non-triggered based PPDU to AP 1704. In order to do so, STA 1706 should observe the NPCA PCH to be idle. In an embodiment, STA 1706 may observe NPCA PCH to be idle. In an embodiment, STA 1706 may have low latency traffic to AP 1704. In an embodiment, having buffered traffic to AP 1704 and since not being triggered during the duration T, STA 1706 may transmit to AP 1704 a frame 1720 on condition that a value of the timer is zero. In an embodiment, frame 1720 may be a non-TB PPDU.

In an embodiment, AP 1704 may receive frame 1720 successfully. In an embodiment, AP 1704 may transmit a frame 1722 in response to frame 1720. In an embodiment, frame 1720 may be a BA frame. In example 1700, STA 1706 may be configured to initiate a second TXOP on the NPCA PCH after the first TXOP. In an embodiment (not shown in FIG. 17), initiating the second TXOP may occur a SIFS or a PIFS after an end of the first TXOP. In an embodiment, initiating the second TXOP may occur a duration T after an end of the first TXOP. In an embodiment, initiating the second TXOP after the first TXOP may comprise re-setting the timer based on the duration. As such, STA 1706 may initiate the second TXOP on the NPCA PCH on condition that a value of the timer is zero. In example 1700, after receiving frame 1722, STA 1706 may re-set the timer based on the duration and may transmit a frame 1724 on condition that a value of the timer is zero (e.g., duration T has elapsed after the reception of frame 1724). In an embodiment, frame 1724 may be a non-TB PPDU. On receiving frame 1724 successfully, AP 1704 may transmit a frame 1726 in response. In an embodiment, frame 1726 may be a BA frame. As illustrated in example 1700, configuring STA 1706 to initiate multiple TXOPs after the duration may facilitate STA 1706 to transmit multiple non-TB PPDUs, which may comprise low latency data.

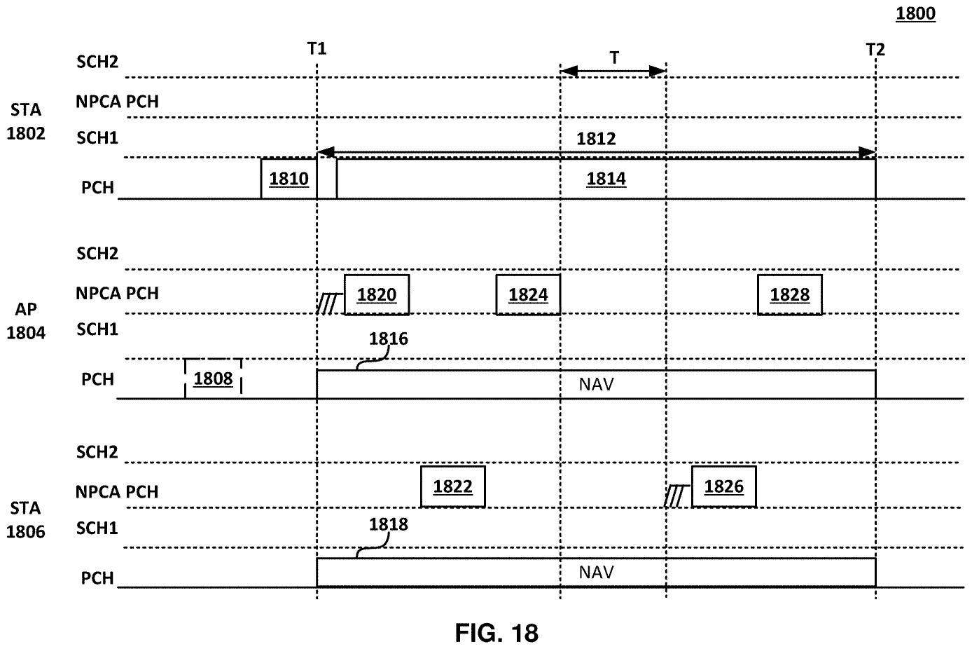

FIG. 18 shows another example 1800 that illustrates an example NPCA operation according to an embodiment. As shown in FIG. 18, example 1800 includes STA 1802, AP 1804, and STA 1806. AP 1804 and STA 1806 may belong to the same BSS. STA 1802 may belong to a different BSS than AP 1804 and STA 1806. In an example, STA 1802 may be an AP STA or a non-AP STA. In an embodiment, AP 1804 may be an AP STA, and STA 1806 may be a non-AP STA. In an embodiment, where AP 1804 is an AP STA and STA 1806 is a non-AP STA, STA 1806 may be associated with AP 1804. In an embodiment, AP 1804 and STA 1806 may support NPCA operation and may operate over a plurality of channels, including a primary channel (PCH), an NPCA primary channel (NPCA PCH), a first secondary channel (SCH1), and a second secondary channel (SCH2).

As shown in FIG. 18, example 1800 may begin with AP 1804 transmitting a frame 1808 to STA 1806 on the PCH. In an embodiment, frame 1808 may comprise a management frame, an action frame, a control frame, a quality of service (QoS) null frame, or a QoS data frame. In an embodiment, where frame 1808 comprises the management frame, the management frame may comprise a beacon frame. In an embodiment, frame 1808 may indicate a duration. In an embodiment, the duration indicates a time period during which STA 1806, while operating on the NPCA PCH, is not allowed/configured to initiate a TXOP on the NPCA PCH. In an embodiment, the duration indicates a time period during which STA 1806 is not allowed/configured to transmit a non-trigger based (non-TB) physical layer protocol data unit (PPDU) to the AP via the NPCA PCH. In another embodiment, the duration indicates a time period during which STA 1806 does not transmit a non-TB PPDU to the AP via the NPCA PCH. In another embodiment, the duration indicates a time period during which STA 1806 is not allowed to transmit a non-TB PPDU to the AP via the NPCA PCH but is allowed to transmit a TB PPDU to the AP via the NPCA PCH.

In an embodiment, the duration may be based on a basic network allocation network (NAV) duration obtained from an inter-BSS PPDU in response to which STA 1806 switches from the PCH to the NPCA PCH. In an embodiment, AP 1804 may inform STA 1806 of the duration to be a percentage/proportion of the basic NAV duration. In another embodiment, the value of the duration may be a value fixed/determined by AP 1804. In an embodiment, AP 1804 may configure the duration for STA 1806 based on a type of traffic that STA 1806 has buffered for AP 1804. In an embodiment (not shown in FIG. 18), there may be other STAs associated with AP 1804 (in addition to STA 1806 being associated with AP 1804), and AP 1804 may configure a respective duration for each STA (e.g., based on the respective traffic buffered at the STA). In another embodiment, AP 1804 may configure/determine the duration based on traffic congestion. In an example, if the traffic is expected to be congested on the NPCA PCH, AP 1804 may set the duration to a higher value. For example, in an embodiment, AP 1804 may set the duration to the value of the basic NAV duration obtained from the inter-BSS PPDU. In another embodiment, AP 1804 may set the duration to a value of a maximum TXOP duration. As such, only triggered uplink transmission may be allowed on the NPCA PCH, while operating on the NPCA PCH.

In another embodiment, AP 1804 may not transmit frame 1808 to STA 1806 on the PCH. In an embodiment, the duration may be predetermined/present, where AP 1804 does not have to inform STA 1806 of the duration with frame 1808. In an embodiment, AP 1804 may have informed STA 1806 of the duration in an earlier frame exchange.

In example 1800, on receiving frame 1808, STA 1806 may determine the duration indicating the time period during which STA 1806, while operating on the NPCA PCH, is not allowed/configured to initiate a TXOP on the NPCA PCH. In another embodiment, STA 1806 may configure the duration, where the duration may be predetermined/preset, without receiving frame 1808. As such, AP 1804 may have informed STA 1806 of the duration in an earlier frame exchange.

Example 1800 may continue with STA 1802 transmitting a frame 1810 on the PCH. By transmitting frame 1810, STA 1802 may obtain a TXOP on the PCH. Frame 1810 may be comprised in a PPDU comprising a TXOP duration field. The TXOP duration field may indicate a TXOP duration 1812. TXOP duration 1812 may indicate a duration that starts by the end of frame 1810 (e.g., starting at a time T1) and that ends at a time T2 as shown in FIG. 18. After transmitting frame 1810, STA 1802 may communicate with its associated STAs via the PCH within TXOP duration 1812. In an embodiment, STA 1802 may perform uplink and/or downlink communications as illustrated with a frame exchange 1814. In example 1800, frame exchange 1814 may extend to the end of TXOP duration 1812.

In an embodiment, on receiving frame 1810, AP 1804 may determine that frame 1810 is comprised in an inter-BSS PPDU (OBSS PPDU). As discussed above in relation to FIG. 11 and in accordance with NPCA operation, based on determining that frame 1810 is comprised in an inter-BSS PPDU, AP 1804 may set a NAV 1816 for the PCH based on TXOP duration 1812 and may switch from the PCH to the NPCA PCH for TXOP duration 1812 (OBSS NAV duration for AP 1804). In example 1800, AP 1804 may switch to the NPCA PCH at a time T1. After switching to the NPCA PCH, AP 1804 may be involved in uplink and/or downlink communications with its associated STAs. In an embodiment, after switching to the NPCA PCH, uplink communications between AP 1804 and its associated STAs (e.g., STA 1806) may be performed via triggered-based (TB) physical layer (PHY) protocol data unit (PPDU) transmission or via non-TB PPDU transmission. In an embodiment, after switching to the NPCA PCH, AP 1804 may perform downlink communications with its associated STAs (e.g., STA 1806). AP 1804 may transmit a frame (e.g., frame 1824) indicating no more downlink data for one or more associated STA (e.g., STA 1806) when AP 1804 has no more buffered downlink traffic. In an embodiment, the time period indicated by the duration (denoted by T in FIG. 18), indicated in frame 1808 or in an earlier frame exchange, may start at the time the frame (e.g., frame 1824) indicating no more downlink data for the STA (e.g., STA 1806) is received by the STA. In another embodiment, the time period indicated by the duration, indicated in frame 1808 or in an earlier frame exchange, may start a short interframe spacing (SIFS) or a point coordination function (PCF) interframe spacing (PIFS) after the time the frame (e.g., frame 1824) indicating no more downlink data for the STA (e.g., STA 1806) is received by the STA. Accordingly, after receiving the frame (e.g., frame 1824) indicating no more downlink data for the STA, a STA associated with AP 1804 (e.g., STA 1806) may only transmit a frame to AP 1804 in response to a trigger frame from AP 1804 during the time period (e.g., T) indicated by the duration. In other words, after receiving the frame (e.g., frame 1824) indicating no more downlink data for the STA, a STA associated with AP 1804 (e.g., STA 1806) may not initiate a transmission if not triggered by AP 1804 during the time period (e.g., T) indicated by the duration.

In an embodiment, on receiving frame 1810, STA 1806 may determine that frame 1810 is comprised in an inter-BSS PPDU (OBSS PPDU). Based on determining that frame 1810 is comprised in an inter-BSS PPDU, STA 1806 may set a NAV 1818 for the PCH based on TXOP duration 1812 and may switch from the PCH to the NPCA PCH for TXOP duration 1812 (OBSS NAV duration for STA 1806). In example 1800, STA 1806 may switch to the NPCA PCH at a time T1. After switching to the NPCA PCH, based on being associated with AP 1804 and being configured/informed to perform TB PPDU transmission or non-TB transmission on the NPCA PCH until the beginning of the time period indicated by the duration (denoted by T in FIG. 18) (e.g., after the reception of frame 1824 by STA 1806), STA 1806 may be involved in downlink communications and/or triggered/untriggered uplink communications with AP 1804. After receiving the frame (e.g., frame 1824) indicating that AP 1804 has no more downlink data for STA 1806, STA 1806 refrains from initiating a TXOP on the NPCA PCH during the time period (e.g., T) indicated by the duration; however, STA 1806 may initiate a TXOP on the NPCA PCH after the time period T, if the NPCA PCH is idle.

In an embodiment, after switching to the NPCA PCH, AP 1804 may start a “MediumSyncDelay” timer for the medium synchronization duration of the NPCA PCH, and if the NPCA PCH is idle (at/after expiration of the MediumSyncDelay timer), AP 1804 may access the NPCA PCH to transmit a frame on the NPCA PCH. In an embodiment, based on the NPCA PCH being idle, AP 1804 may obtain control of the NPCA PCH and transmit a frame 1820 to STA 1806. In an embodiment, frame 1820 may be a PPDU. In response to frame 1820, STA 1806 may transmit a frame 1822 to AP 1804. In an embodiment, frame 1822 may be a BA frame. In an embodiment, AP 1804 may not have buffered data for STA 1806 and may want to perform only TB PPDU transmission with its associated STAs in the duration T. Based on having no more buffered downlink data for STA 1806, AP 1804 may transmit frame 1824 indicating no more downlink data for STA 1806. In an embodiment, frame 1824 may comprise a management frame, an action frame, a control frame, a quality of service (QoS) null frame, or a QoS data frame. In an embodiment (not shown in FIG. 18), AP 1804 may perform TB PPDU transmission with its associated STAs during the duration, which starts with the reception of frame 1824 by STA 1806. In another embodiment (not shown in FIG. 18), AP 1804 may perform TB PPDU transmission with its associated STAs during the duration, which starts a SIFS or a PIFS after the reception of frame 1824 by STA 1806.

In an embodiment, receiving frame 1824, STA 1806 may set a timer based on the duration. In an embodiment, the timer starts with the reception of frame 1824. In another embodiment, the timer starts a SIFS or a PIFS after the reception of frame 1824. In an embodiment, when the timer has a nonzero value, STA 1806 is not allowed/configured to initiate a TXOP on the NPCA PCH. In an embodiment, after the timer is expired (value of the timer is zero), STA 1806 may initiate a TXOP on the NPCA PCH to transmit a non-triggered based PPDU to AP 1804. In order to do so, STA 1806 should observe the NPCA PCH to be idle. In an embodiment, STA 1806 may observe NPCA PCH to be idle. In an embodiment, STA 1806 may have low latency traffic to AP 1804 (e.g., low latency traffic may have arrived during the duration T). In an embodiment, having buffered traffic to AP 1804 and since not being triggered during the duration T, STA 1806 may transmit to AP 1804 a frame 1826 on condition that a value of the timer is zero. In an embodiment, frame 1826 may be a non-TB PPDU.

In an embodiment, AP 1804 may receive frame 1826 successfully. In an embodiment, AP 1804 may transmit a frame 1828 in response to frame 1826. In an embodiment, frame 1828 may be a BA frame. As illustrated in example 1800, AP 1804 may start the time period (e.g., T) during which STA 1806, while operating on the NPCA PCH, is not allowed/configured to initiate a TXOP on the NPCA PCH, after finishing transmitting downlink data to its associated STAs.

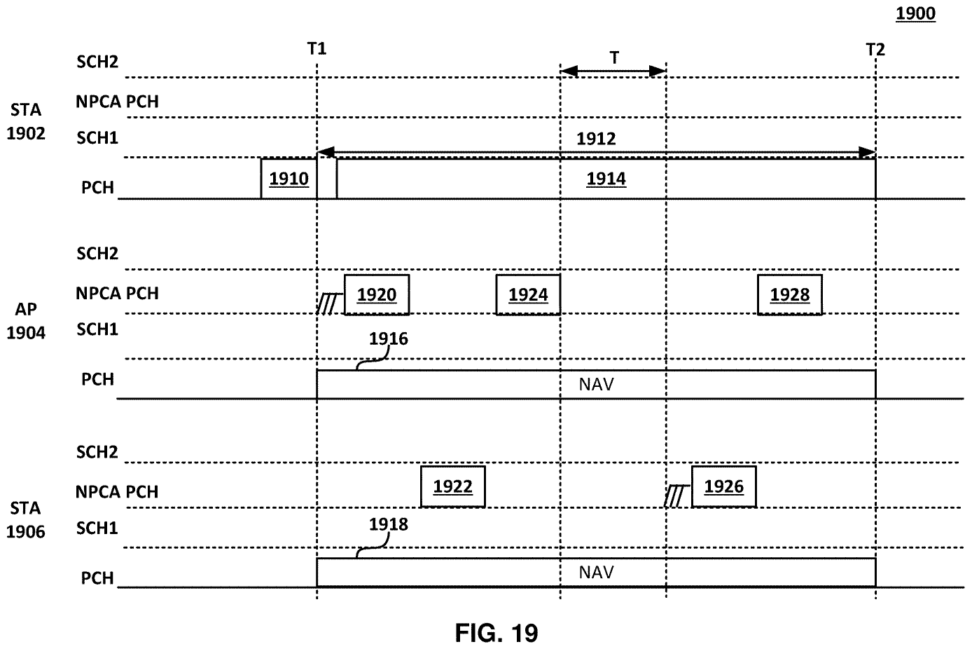

FIG. 19 shows another example 1900 that illustrates an example NPCA operation according to an embodiment. As shown in FIG. 19, example 1900 includes STA 1902, AP 1904, and STA 1906. AP 1904 and STA 1906 may belong to the same BSS. STA 1902 may belong to a different BSS than AP 1904 and STA 1906. In an example, STA 1902 may be an AP STA or a non-AP STA. In an embodiment, AP 1904 may be an AP STA, and STA 1906 may be a non-AP STA. In an embodiment, where AP 1904 is an AP STA and STA 1906 is a non-AP STA, STA 1906 may be associated with AP 1904. In an embodiment, AP 1904 and STA 1906 may support NPCA operation and may operate over a plurality of channels, including a primary channel (PCH), an NPCA primary channel (NPCA PCH), a first secondary channel (SCH1), and a second secondary channel (SCH2).

As shown in FIG. 19, example 1900 may begin with STA 1902 transmitting a frame 1910. By transmitting frame 1910, STA 1902 may obtain a TXOP on the PCH. Frame 1910 may be comprised in a PPDU comprising a TXOP duration field. The TXOP duration field may indicate a TXOP duration 1912. TXOP duration 1912 may indicate a duration that starts by the end of frame 1910 (e.g., starting at a time T1) and that ends at a time T2 as shown in FIG. 19. After transmitting frame 1910, STA 1902 may communicate with its associated STAs via the PCH within TXOP duration 1912. In an embodiment, STA 1902 may perform uplink and/or downlink communications as illustrated with a frame exchange 1914. In example 1900, frame exchange 1914 may extend to the end of TXOP duration 1912.

In an embodiment, on receiving frame 1910, AP 1904 may determine that frame 1910 is comprised in an inter-BSS PPDU (OBSS PPDU). As discussed above in relation to FIG. 11 and in accordance with NPCA operation, AP 1904 may set a NAV 1916 for the PCH based on TXOP duration 1912 and may switch to the NPCA PCH for TXOP duration 1912 (OBSS NAV duration for AP 1904). In example 1900, AP 1904 may switch to the NPCA PCH at a time T1. After switching to the NPCA PCH, AP 1904 may be involved in uplink and/or downlink communications with its associated STAs. In example 1900, after switching to the NPCA PCH, uplink communications between AP 1904 and its associated STAs (e.g., STA 1906) may be performed via triggered-based (TB) physical layer (PHY) protocol data unit (PPDU) transmission or non-TB PPDU transmission.

In an embodiment, on receiving frame 1910, STA 1906 may determine that frame 1910 is comprised in an inter-BSS PPDU (OBSS PPDU). Based on supporting/enabling NPCA operation, STA 1906 may set a NAV 1918 for the PCH based on TXOP duration 1912 and may switch to the NPCA PCH for TXOP duration 1912 (OBSS NAV duration for STA 1906). In example 1900, STA 1906 may switch to the NPCA PCH at a time T1. After switching to the NPCA PCH, based on being associated with AP 1204 and being configured to perform TB PPDU transmission or non-TB transmission on the NPCA PCH after switching to the NPCA PCH, STA 1906 may be involved in downlink communications and/or triggered/untriggered uplink communications with AP 1904.

In an embodiment, after switching to the NPCA PCH, AP 1904 may start a “MediumSyncDelay” timer for the medium synchronization duration of the NPCA PCH, and if the NPCA PCH is idle (at/after expiration of the MediumSyncDelay timer), AP 1904 may access the NPCA PCH to transmit a frame on the NPCA PCH. In an embodiment, based on the NPCA PCH being idle, AP 1904 may obtain control of the NPCA PCH and transmit a frame 1920 to STA 1906. In an example, frame 1920 may be a PPDU. In response to frame 1920, STA 1906 may transmit a frame 1922. In an embodiment, frame 1922 may be a BA frame.

In an embodiment, while communicating on the NPCA PCH, AP 1904 may be configured to initiate/start a duration, where the duration indicates a time period during which STA 1906, while operating on the NPCA PCH, is not allowed/configured to initiate a TXOP on the NPCA PCH. As such, AP 1904 may transmit a frame 1924. In an embodiment, frame 1924 may comprise a management frame, an action frame, a control frame, a quality of service (QoS) null frame, or a QoS data frame. In an embodiment, frame 1924 may indicate a duration. In an embodiment, the duration indicates a time period during which STA 1906 is not allowed/configured to transmit a non-trigger based (non-TB) physical layer protocol data unit (PPDU) to the AP via the NPCA PCH. In another embodiment, the duration indicates a time period during which STA 1906 does not transmit a non-TB PPDU to the AP via the NPCA PCH. In another embodiment, the duration indicates a time period during which STA 1906 is not allowed to transmit a non-TB PPDU to the AP via the NPCA PCH but is allowed to transmit a TB PPDU to the AP via the NPCA PCH.

In an embodiment, the duration may be based on a basic network allocation network (NAV) duration obtained from an inter-BSS PPDU in response to which STA 1906 switches from the PCH to the NPCA PCH. In an embodiment, AP 1904 may inform STA 1906 of the duration to be a percentage/proportion of the basic NAV duration. In another embodiment, the value of the duration may be a value fixed/determined by AP 1904. In an embodiment, AP 1904 may configure the duration for STA 1906 based on a type of traffic that STA 1906 has buffered for AP 1904. In an embodiment (not shown in FIG. 19), there may be other STAs associated with AP 1904 (in addition to STA 1906 being associated with AP 1904), and AP 1904 may configure a respective duration for each STA (e.g., based on the respective traffic buffered at the STA). In another embodiment, AP 1904 may configure/determine the duration based on traffic congestion. In an example, if the traffic is expected to be congested on the NPCA PCH, AP 1904 may set the duration to a higher value. For example, in an embodiment, AP 1904 may set the duration to the value of the basic NAV duration obtained from the inter-BSS PPDU. In another embodiment, AP 1904 may set the duration to a value of a maximum TXOP duration. As such, only triggered uplink transmission may be allowed on the NPCA PCH, while operating on the NPCA PCH.

In example 1900, on receiving frame 1924, STA 1906 may determine the duration indicating the time period during which STA 1906, while operating on the NPCA PCH, is not allowed/configured to initiate a TXOP on the NPCA PCH.

In an embodiment, receiving frame 1924, STA 1906 may set a timer based on the duration. In an embodiment, the timer starts with the reception of frame 1924. In another embodiment, the timer starts a SIFS or a PIFS after the reception of frame 1924. In an embodiment, when the timer has a nonzero value, STA 1906 is not allowed/configured to initiate a TXOP on the NPCA PCH. In an embodiment, after the timer is expired (value of the timer is zero), STA 1906 may initiate a TXOP on the NPCA PCH to transmit a non-triggered based PPDU to AP 1904. In order to do so, STA 1906 should observe the NPCA PCH to be idle. In an embodiment, STA 1906 may observe NPCA PCH to be idle. In an embodiment, STA 1906 may have low latency traffic to AP 1904 (e.g., low latency traffic may have arrived during the duration T). In an embodiment, having buffered traffic to AP 1904 and since not being triggered during the duration T, STA 1906 may transmit to AP 1904 a frame 1926 on condition that a value of the timer is zero. In an embodiment, frame 1926 may be a non-TB PPDU.

In an embodiment, AP 1904 may receive frame 1926 successfully. In an embodiment, AP 1904 may transmit a frame 1928 in response to frame 1926. In an embodiment, frame 1928 may be a BA frame. As illustrated in example 1900, AP 1904 may inform STA 1906 of a duration, where the duration indicates a time period during which STA 1906, while operating on the NPCA PCH, is not allowed/configured to initiate a TXOP on the NPCA PCH, during an ongoing communication on the NPCA PCH (e.g., informing via frame 1924).

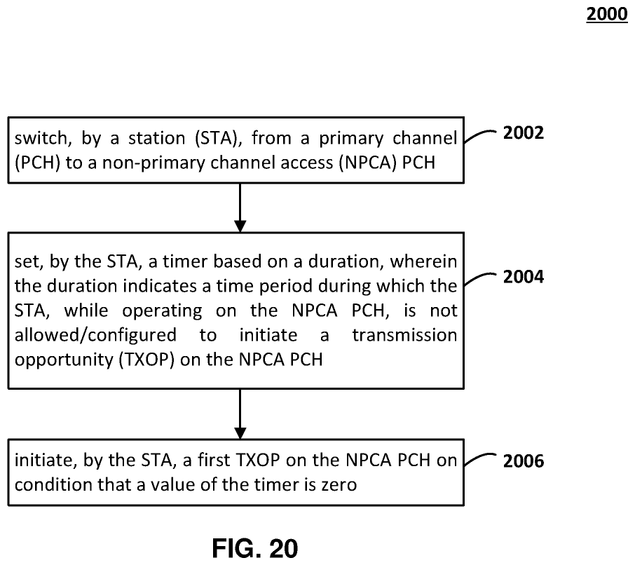

FIG. 20 illustrates an example process 2000 according to an embodiment. Example process 2000 is provided for the purpose of illustration only and is not limiting of embodiments. Example process 2000 may be performed by a station (STA), such as STA 1406, STA 1506, STA 1606, STA 1706, STA 1806, or STA 1906, for example. As shown in FIG. 20, example process 2000 may include steps 2002, 2004, and 2006.

Step 2002 includes switching, by the STA, from a primary channel (PCH) to a non-primary channel access (NPCA) PCH.

Step 2004 includes setting, by the STA, a timer based on a duration, wherein the duration indicates a time period during which the STA, while operating on the NPCA PCH, is not allowed/configured to initiate a transmission opportunity (TXOP) on the NPCA PCH.

Step 2006 includes initiating, by the STA, a first TXOP on the NPCA PCH on condition that a value of the timer is zero.

In an embodiment, the switching occurs at a first time, and wherein a start time of the time period is equal to the first time. In another embodiment, the switching occurs at a first time, and wherein a start time of the time period is equal to the first time plus a second time.

In an embodiment, process 2000 may further comprise receiving, by the STA from the AP and via the NPCA PCH, a first frame indicating no more downlink data for the STA, and wherein a start time of the time period is equal to a reception time of the first frame. In another embodiment, process 2000 may further comprise receiving, by the STA from the AP and via the NPCA PCH, a first frame indicating no more downlink data for the STA, and wherein a start time of the time period is equal to a reception time of the first frame plus a second time.

In an embodiment, process 2000 may further comprise receiving, by the STA from the AP and via the NPCA PCH, a first frame informing the STA of the duration, and wherein a start time of the time period is equal to a reception time of the first frame. In another embodiment, process 2000 may further comprise receiving, by the STA from the AP and via the NPCA PCH, a first frame informing the STA of the duration, and wherein a start time of the time period is equal to a reception time of the first frame plus a second time.

In an embodiment, the second time comprises a short interframe spacing (SIFS) or a point coordination function (PCF) interframe spacing (PIFS).

In an embodiment, the switching is based on determining, by the STA, that a physical layer (PHY) protocol data unit (PPDU) being received via the PCH comprises an inter-basic service set (inter-BSS) PPDU.

In an embodiment, the duration comprises a value of zero. In another embodiment, the duration comprises a portion of a basic network allocation network (NAV) duration obtained from the inter-BSS PPDU.

In an embodiment, process 2000 may further comprise initiating, by the STA, a second TXOP on the NPCA PCH after the first TXOP. In an embodiment, initiating the second TXOP after the first TXOP comprises re-setting the timer based on the duration. In another embodiment, the initiating of the second TXOP occurs a short interframe spacing (SIFS) or a point coordination function (PCF) interframe spacing (PIFS) after an end of the first TXOP.

In an embodiment, the duration comprises a value of a basic network allocation network (NAV) duration obtained from the inter-BSS PPDU. In another embodiment, the duration comprises a value of a maximum TXOP duration. In an embodiment, the duration is based on a traffic type. In another embodiment, the duration is based on traffic congestion.

In an embodiment, process 2000 may further comprise receiving, by the STA from the AP, a second frame indicating the duration. In an embodiment, the second frame comprises a management frame, an action frame, a control frame, a quality of service (QoS) null frame, or a QoS data frame. In an embodiment, where the second frame comprises the management frame, the management frame comprises a beacon frame.

In an embodiment, process 2000 may further comprise transmitting, by the STA to the AP, a third frame requesting the duration. In an embodiment, process 2000 may further comprise receiving, by the STA from the AP, a fourth frame in response to the third frame. In an embodiment, the fourth frame indicates acceptance of the requested duration. In another embodiment, the fourth frame indicates rejection of the requested duration. In another embodiment, the fourth frame indicates a second duration different than the requested duration.

In an embodiment, the STA not being allowed/configured to initiate a transmission opportunity (TXOP) on the NPCA PCH comprises the STA not being allowed/configured to transmit a non-trigger based (non-TB) physical layer protocol data unit (PPDU) to the AP via the NPCA PCH. In another embodiment, the STA not being allowed/configured to initiate a transmission opportunity (TXOP) on the NPCA PCH comprises the STA not transmitting a non-trigger based (non-TB) physical layer protocol data unit (PPDU) to the AP via the NPCA PCH.

In an embodiment, initiating, by the STA, a first TXOP on the NPCA PCH on condition that a value of the timer is zero comprises transmitting, by the STA, a first transmission on the NPCA PCH after the timer is expired, wherein the STA is not allowed/configured to initiate the first transmission when the timer has a nonzero value. In another embodiment, initiating, by the STA, a first TXOP on the NPCA PCH on condition that a value of the timer is zero comprises transmitting, by the STA to the AP, a first non-TB PPDU on condition that a value of the timer is zero.

In an embodiment, process 2000 may further comprise transmitting, by the STA to the AP and before transmitting the first non-TB PPDU, a fifth frame. In an embodiment, the fifth frame comprises an initial control frame (ICF). In another embodiment, the fifth frame comprises a request-to-send (RTS) frame. In an embodiment, process 2000 may further comprise receiving, by the STA from the AP, a sixth frame in response to the fifth frame. In an embodiment, the sixth frame comprises an initial control response frame (ICR). In another embodiment, the sixth frame comprises a clear-to-send (CTS) frame.

In an embodiment, the first frame comprises a management frame, an action frame, a control frame, a quality of service (QoS) null frame, or a QoS data frame. In an embodiment, the third frame comprises a management frame, an action frame, a control frame, a quality of service (QoS) null frame, or a QoS data frame. In an embodiment, the fourth frame comprises a management frame, an action frame, a control frame, a quality of service (QoS) null frame, or a QoS data frame.

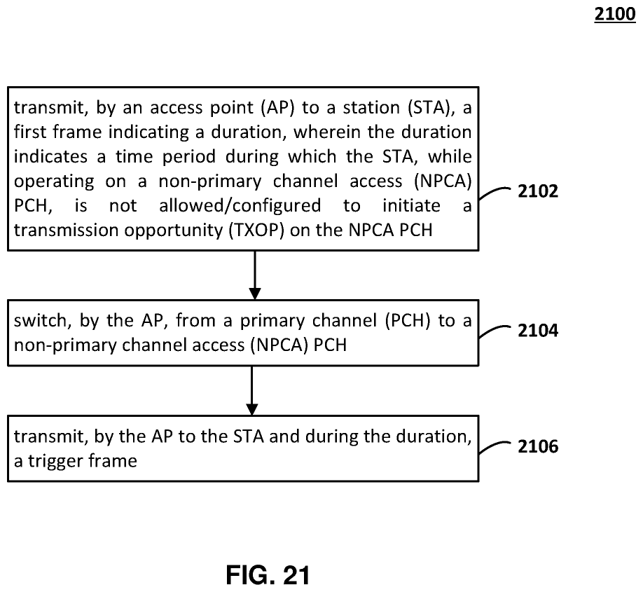

FIG. 21 illustrates another example process 2100 according to an embodiment. Example process 2100 is provided for the purpose of illustration only and is not limiting of embodiments. Example process 2100 may be performed by an access point (AP), such as AP 1404, AP 1504, AP 1604, AP 1704, AP 1804, or AP 1904, for example. As shown in FIG. 21, example process 2100 may include steps 2102, 2104, and 2106.

Step 2102 includes transmitting, by an access point (AP) to a station (STA), a first frame indicating a duration, wherein the duration indicates a time period during which the STA, while operating on a non-primary channel access (NPCA) PCH, is not allowed/configured to initiate a transmission opportunity (TXOP) on the NPCA PCH.

Step 2104 includes switching, by the AP, from a primary channel (PCH) to a non-primary channel access (NPCA) PCH.

Step 2106 includes transmitting, by the AP to the STA and during the duration, a trigger frame.

In an embodiment, process 2100 may further comprise receiving, by the AP from the STA and during the duration, a trigger-based (TB) PPDU in response to the trigger frame.

In an embodiment, the switching occurs at a first time, and wherein a start time of the time period is equal to the first time. In another embodiment, the switching occurs at a first time, and wherein a start time of the time period is equal to the first time plus a second time. In an embodiment, the transmitting of the first frame is on the PCH, before the switching.

In an embodiment, process 2100 may further comprise transmitting, by the AP to the STA and via the NPCA PCH, a second frame indicating no more downlink data for the STA, and wherein a start time of the time period is equal to a reception time of the second frame. In another embodiment, transmitting, by the AP to the STA and via the NPCA PCH, a second frame indicating no more downlink data for the STA, and wherein a start time of the time period is equal to a reception time of the second frame plus a second time.

In an embodiment, the transmitting of the first frame is on the NPCA PCH and after the switching, and wherein a start time of the time period is equal to a reception time of the first frame. In another embodiment, the transmitting of the first frame is on the NPCA PCH and after the switching, and wherein a start time of the time period is equal to a reception time of the first frame plus a second time.

In an embodiment, the second time comprises a short interframe spacing (SIFS) or a point coordination function (PCF) interframe spacing (PIFS).

In an embodiment, the switching is based on determining, by the AP, that a physical layer (PHY) protocol data unit (PPDU) being received via the PCH comprises an inter-basic service set (inter-BSS) PPDU.

In an embodiment, the duration comprises a value of zero. In another embodiment, the duration comprises a portion of a basic network allocation network (NAV) duration obtained from the inter-BSS PPDU. In another embodiment, the duration comprises a value of a basic network allocation network (NAV) duration obtained from the inter-BSS PPDU. In another embodiment, the duration comprises a value of a maximum TXOP duration. In an embodiment, the duration is based on a traffic type. In another embodiment, the duration is based on traffic congestion.

In an embodiment, the first frame comprises a management frame, an action frame, a control frame, a quality of service (QoS) null frame, or a QoS data frame. In an embodiment, where the first frame comprises the management frame, the management frame comprises a beacon frame.

In an embodiment, process 2100 may further comprise receiving, by the AP from the STA, a third frame requesting a second duration before the transmitting of the first frame. In an embodiment, the first frame further indicates acceptance of the requested second duration, and wherein the duration is equal to the second duration. In another embodiment, the first frame further indicates rejection of the requested second duration. In another frame, the first frame indicates the duration, wherein the duration is different than the second duration.

In an embodiment, the STA not being allowed/configured to initiate a transmission opportunity (TXOP) on the NPCA PCH comprises the STA not being allowed/configured to transmit a non-trigger based (non-TB) physical layer protocol data unit (PPDU) to the AP via the NPCA PCH. In another embodiment, the STA not being allowed/configured to initiate a transmission opportunity (TXOP) on the NPCA PCH comprises the STA not transmitting a non-trigger based (non-TB) physical layer protocol data unit (PPDU) to the AP via the NPCA PCH.

In an embodiment, process 2100 may further comprise receiving, by the AP from the STA, a first non-TB PPDU after an end of the duration. In an embodiment, process 2100 may further comprise receiving, by the AP from the STA and before receiving the first non-TB PPDU, a fourth frame. In an embodiment, the fourth frame comprises an initial control frame (ICF). In another embodiment, the fourth frame comprises a request-to-send (RTS) frame. In an embodiment, process 2100 may further comprise transmitting, by the AP to the STA, a fifth frame in response to the fourth frame. In an embodiment, the fifth frame comprises an initial control response frame (ICR). In another embodiment, the fifth frame comprises a clear-to-send (CTS) frame.

In an embodiment, the second frame comprises a management frame, an action frame, a control frame, a quality of service (QoS) null frame, or a QoS data frame. In an embodiment, the third frame comprises a management frame, an action frame, a control frame, a quality of service (QoS) null frame, or a QoS data frame.

What is claimed is:

1. A station (STA) comprising:
one or more processors; and
memory storing instructions that, when executed by the one or more processors, cause the STA to:
receive, from an access point (AP), a beacon frame indicating a duration, wherein the duration indicates a time period during which the STA, while operating on a non-primary channel access (NPCA) primary channel (NPCA PCH), is not allowed to initiate a transmission opportunity (TXOP) on the NPCA PCH;
determine that a physical layer (PHY) protocol data unit (PPDU) being received via a primary channel (PCH) comprises an inter-basic service set (inter-BSS) PPDU;
switch from the PCH to the NPCA PCH based on determining that the PPDU being received via the PCH comprises an inter-BSS PPDU;
set a timer based on the duration; and
initiate a first TXOP on the NPCA PCH on condition that a value of the timer is zero.

2. The STA of claim 1, wherein the instructions, when executed by the one or more processors, cause the STA to switch at a first time, and wherein a start time of the time period is equal to the first time.

3. The STA of claim 1, wherein the duration is based on a traffic type.

4. The STA of claim 1, wherein the STA not being allowed to initiate the TXOP on the NPCA PCH comprises the STA not being allowed to transmit a non-trigger based (non-TB) PPDU via the NPCA PCH.

5. The STA of claim 1, wherein the STA not being allowed to initiate the TXOP on the NPCA PCH comprises the STA not transmitting a non-trigger based (non-TB) PPDU via the NPCA PCH.

6. The STA of claim 1, wherein the instructions, when executed by the one or more processors, further cause the STA to transmit a first transmission on the NPCA PCH after the timer expires, wherein the STA is not allowed to initiate the first transmission when the timer has a nonzero value.

7. The STA of claim 1, wherein the instructions, when executed by the one or more processors, further cause the STA to transmit a first non-trigger based (non-TB) PPDU on condition that a value of the timer is zero.

8. The STA of claim 1, wherein the instructions, when executed by the one or more processors, further cause the STA to initiate a second TXOP on the NPCA PCH after the first TXOP.

9. The STA of claim 8, wherein the instructions, when executed by the one or more processors, further cause the STA to re-set the timer based on the duration.

10. An access point (AP) comprising:
one or more processors; and
memory storing instructions that, when executed by the one or more processors, cause the AP to:
transmit, to a station (STA), a beacon frame indicating a duration, wherein the duration indicates a time period during which the STA, while operating on a non-primary channel access (NPCA) primary channel (NPCA PCH), is not allowed to initiate a transmission opportunity (TXOP) on the NPCA PCH;
switch from a primary channel (PCH) to the NPCA PCH;
transmit, to the STA and during the duration, a trigger frame; and
receive, from the STA and during the duration, a trigger-based (TB) physical layer (PHY) protocol data unit (PPDU) in response to the trigger frame.

11. The AP of claim 10, wherein the instructions, when executed by the one or more processors, cause the AP to transmit the beacon frame on the PCH before switching to the NPCA PCH.

12. The AP of claim 10, wherein the instructions, when executed by the one or more processors, cause the AP to switch from the PCH to the NPCA PCH based on determining that a PPDU being received via the PCH comprises an inter-basic service set (inter-BSS) PPDU.

13. The AP of claim 10, wherein the duration is based on a traffic type.

14. The AP of claim 10, wherein the STA not being allowed to initiate the TXOP on the NPCA PCH comprises the STA not being allowed to transmit a non-trigger based (non-TB) PPDU to the AP via the NPCA PCH.

15. The AP of claim 10, wherein the instructions, when executed by the one or more processors, further cause the AP to receive, from the STA, a first non-trigger based (non-TB) PPDU after an end of the duration.

16. The AP of claim 10, wherein the STA not being allowed to initiate the TXOP on the NPCA PCH comprises the STA not transmitting a non-trigger based (non-TB) PPDU to the AP via the NPCA PCH.

17. A non-transitory computer-readable medium comprising instructions that, when executed by one or more processors of a station (STA), cause the STA to:
receive, from an access point (AP), a beacon frame indicating a duration, wherein the duration indicates a time period during which the STA, while operating on a non-primary channel access (NPCA) primary channel (NPCA PCH), is not allowed to initiate a transmission opportunity (TXOP) on the NPCA PCH;
determine that a physical layer (PHY) protocol data unit (PPDU) being received via a primary channel (PCH) comprises an inter-basic service set (inter-BSS) PPDU;
switch from the PCH to the NPCA PCH based on determining that the PPDU being received via the PCH comprises an inter-BSS PPDU;
set a timer based on the duration; and
initiate a first TXOP on the NPCA PCH on condition that a value of the timer is zero.

18. The non-transitory computer-readable medium of claim 17, wherein the duration is based on a traffic type.

19. The non-transitory computer-readable medium of claim 17, wherein the STA not being allowed to initiate the TXOP on the NPCA PCH comprises the STA not being allowed to transmit a non-trigger based (non-TB) PPDU via the NPCA PCH.

20. The non-transitory computer-readable medium of claim 17, wherein the instructions, when executed by the one or more processors, further cause the STA to transmit a first transmission on the NPCA PCH after the timer expires, wherein the STA is not allowed to initiate the first transmission when the timer has a nonzero value.
